(19) United States
(12) Patent Application Publication
(10) Pub. No.: US 2025/0124071 A1
(43) Pub. Date: Apr. 17, 2025

(54) ELECTRONIC DEVICE FOR GENERATING ACTIVE EXPERIENCE FILE FOR EACH MUSIC FILE, AND OPERATION METHOD OF THE SAME

(71) Applicant: Verses, Inc., Incheon (KR)

(72) Inventors: Sung-Wook LEE, Incheon (KR); Kyung-Tae KIM, Incheon (KR); Jung-Woo KANG, Incheon (KR)

(21) Appl. No.: 18/916,722

(22) Filed: Oct. 16, 2024

(30) Foreign Application Priority Data
Oct. 16, 2023 (KR) 10-2023-0137356
Sep. 6, 2024 (KR) 10-2024-0121883
Sep. 6, 2024 (KR) 10-2024-0121884

(51) Int. Cl. G06F 16/435; G06F 16/44; G06T 15/00; G10H 1/00

(52) U.S. Cl. CPC G06F 16/435; G06F 16/44; G06T 15/00; G10H 1/0008; G10H 2240/011

(57) ABSTRACT

According to various embodiments, there may be provided an operation method of a server, including: obtaining an audio file and a graphic file; obtaining a plurality of audio sources and a plurality of visual sources based on at least one of the audio file or the graphic file; obtaining a plurality of processed audio sources based on changing at least some characteristics of the plurality of audio sources; obtaining a plurality of processed visual sources based on changing at least some characteristics of the plurality of visual sources; and generating at least one active experience file based on generating at least one first audio source selected from the plurality of processed audio sources, at least one first visual source selected from the plurality of processed visual sources, and a specific kind of interaction selected by a user in a related form, wherein, when the specific kind of interaction is received based on the at least one active experience file, the electronic device of the user is set to provide the at least one first audio source and the at least one first visual source.

### CROSS-REFERENCE TO RELATED APPLICATIONS

This application is Korean Patent Application No. 10-2023-0137356, filed Oct. 16, 2023, Korean Patent Application No. 10-2024-0121883, filed Sep. 6, 2024, the disclosures, Korean Patent Application No. 10-2024-0121884, filed Sep. 6, 2024, the disclosures of which are herein incorporated by reference in their entirety.

### BACKGROUND

### 1. Field

The present disclosure relates to an electronic device for generating and reproducing active experience files for each music file, and a method of operating the same.

### 2. Description of Related Art

Since the music began to be recorded and appreciated using the storage medium, the music became the subject of passive/passive appreciation, and active and leading participation in music has been regarded as a musical expert's area.

In addition, the length of a conceptual music has been determined due to the physical limits of the record plate used as the initial storage medium, and even in the era of digital music that deviates from the physical limits of the record plate, the length of a conceptual music has been established as the length of popular music.

As a result, the majority of consumers of music living in the modern society have to stay in a limited role of passive/passive appreciation of a given music within a limited length of time, losing one of the original enjoyments of music that participate in music actively and leadingly as much as the desired time.

Therefore, in order to return the original enjoyments of music to consumers of music, there may be a need for an audio source playback method that is densely designed to reduce the barrier of participation in music, use a limited audio source but to escape the length of a conceptual music, and a music application using the same.

### SUMMARY

When a conventional music file is reproduced, as a plurality of sound sources constituting the music file are reproduced, only the viewing experience can be manually provided to the viewer according to the manufacturer's intention. Recently, technologies for experiencing music using various application content such as game, metaverse, etc., have been implemented, but since the operation burden for producing the application content for one music file is high, it is difficult to practically use the active experience. According to various embodiments, the electronic device and the operation method thereof may be implemented to acquire a plurality of sound sources based on the uploaded music file, acquire a plurality of graphic sources based on the uploaded graphic file, and generate the active experience content for each music file that is uploaded based on the plurality of sound sources and the plurality of graphic sources. Accordingly, the operation burden for generating the content for actively experiencing music is reduced, so that the practicality of the active music experience can be improved. In addition, according to various embodiments, the electronic device and the operation method thereof may provide the sound source and the graphic source generation function for generating the active experience file based on the generative ai, so that the operation burden for generating the active experience file can be further reduced.

In addition, when the sound source and the graphic source corresponding to the sound source are provided based on the active experience file, the sync of providing the content may be inaccurate based on the difference between the time unit in which the sound source is provided and the time unit in which the graphic source is provided. According to various embodiments, the electronic device and the operation method thereof may improve the quality of the content provided to the user by synchronizing the time of providing each of the sound source and the graphic source when the active experience file is reproduced.

In addition, according to various embodiments, the electronic device and the operation method thereof may provide a graphic user interface including a 3D graphic space in which the character and the character corresponding to the user are movable based on the active experience file, so that the user's convenience to which the active music experience file is provided can be improved.

According to various embodiments, there may be provided an operation method of a server, including: obtaining an audio file and a graphic file; obtaining a plurality of audio sources and a plurality of visual sources based on at least one of the audio file or the graphic file; obtaining a plurality of processed audio sources based on changing characteristics of at least some of the plurality of audio sources; obtaining a plurality of processed visual sources based on changing characteristics of at least some of the plurality of visual sources; and generating at least one active experience file based on generating at least one first audio source selected from the plurality of processed audio sources, at least one first visual source selected from the plurality of processed visual sources, and a specific kind of interaction selected by a user in a related form, wherein, when the specific kind of interaction is received based on the at least one active experience file, the electronic device of the user is set to provide the at least one first audio source and the at least one first visual source.

According to various embodiments, the technical solution is not limited to the above-described solutions, and the solutions not mentioned may be clearly understood by those skilled in the art from this specification and the accompanying drawings.

According to various embodiments, it is possible to provide an electronic device and an operation method thereof that are implemented to acquire a plurality of sound sources based on an uploaded music file, acquire a plurality of graphic sources based on an uploaded graphic file, and generate active experience content for each music file that is uploaded based on the plurality of sound sources and the plurality of graphic sources. Accordingly, the operation burden for generating content for actively experiencing music is reduced, so that the practicality of active music experience can be improved.

According to various embodiments, it is possible to provide an electronic device and an operation method thereof that provides a function of generating a sound source and a graphic source for generating an active experience file based on the generative ai, thereby further reducing the operation burden for generating the active experience file.

According to various embodiments, it is possible to provide an electronic device and an operation method thereof that synchronize a time for providing each of the sound source and the graphic source when the active experience file is reproduced, thereby adjusting a sink of content provided to the user, thereby improving the quality of content provided to the user.

According to various embodiments, it is possible to provide an electronic device and an operation method thereof that provides a graphic user interface including a 3D graphic space in which a character and a character corresponding to the user are movable based on the active experience file, thereby improving the convenience of the user receiving the active music experience file.

### BRIEF DESCRIPTION OF THE DRAWINGS

FIG. 1A is a diagram illustrating an example of a component of an active music experience system according to various embodiments.

FIG. 1B is a diagram for describing an example of an active experience file according to various embodiments.

FIG. 2 is a block diagram illustrating an example of a component of a server according to various embodiments.

FIG. 3 is a diagram for describing an example of an authoring module according to various embodiments.

FIG. 4A is a diagram for describing an example of a generation module according to various embodiments.

FIG. 4B is a diagram for describing another example of a generation module according to various embodiments.

FIG. 4C is a diagram for describing still another example of a generation module according to various embodiments.

FIG. 5 is a block diagram illustrating an example of a component of a user device according to various embodiments.

FIG. 6 is a diagram for describing an example of a reproduction module according to various embodiments.

FIG. 7 is a flowchart illustrating an example of an operation method of an electronic device for generating an active experience file according to various embodiments.

FIG. 8 is a diagram for describing an example of an operation of generating an active experience file using an authoring module of an electronic device according to various embodiments.

FIG. 9A is a diagram for describing an example of an active experience file reproduced based on a user input according to various embodiments.

FIG. 9B is a diagram for describing an example of an active experience file reproduced based on an object interaction according to various embodiments.

FIG. 10 is a diagram for describing an example of content reproduced based on an active experience file according to various embodiments.

FIG. 11 is a flowchart illustrating an example of an operation method of an electronic device for generating different active experience files for each upload file according to various embodiments.

FIG. 12 is a diagram for describing an example of an active experience file generated based on different files according to various embodiments.

FIG. 13 is a flowchart illustrating an example of an operation method of an electronic device for generating a source based on a generation module according to various embodiments.

FIG. 14 is a flowchart illustrating an example of an operation method of an electronic device for reproducing an active experience file based on a reproduction module according to various embodiments.

FIG. 15 is a diagram for describing an example of an operation of synchronizing a reproduction timing of an audio source and a visual source using a sink module according to various embodiments.

FIG. 16A is a diagram for describing an example of an operation for providing metaverse music content of a user device according to various embodiments.

FIG. 16B is a diagram for describing an example of content included in metaverse music content according to various embodiments.

FIG. 17 is a flowchart illustrating an example of an operation method of an electronic device for sequentially providing music when character moves.

FIG. 18 is a diagram illustrating an example of an audio source set along a path of a map space according to various embodiments.

FIG. 19 is a flowchart illustrating an example of an operation method of an electronic device for providing sound corresponding to a motion of a character according to various embodiments.

FIG. 20 is a flowchart illustrating an example of an operation method of an electronic device for generating a graphic object associated with a musical experience according to various embodiments.

FIG. 21A is a diagram illustrating an example of playback of an audio source based on a graphic object associated with a musical experience according to various embodiments.

FIG. 21B is a diagram illustrating an example of playback of an audio source based on a graphic object associated with a musical experience according to various embodiments.

FIG. 22 is a flowchart illustrating an example of an operation method of an electronic device for sharing a musical experience according to various embodiments.

FIG. 23 is a diagram illustrating an example of an operation of sharing a graphic object associated with a musical experience for each of a plurality of users according to various embodiments.

FIG. 24 is a flowchart illustrating an example of an operation method of an electronic device for generating an active experience music video according to various embodiments.

FIG. 25 is a diagram illustrating an example of content for generating a music video according to various embodiments.

FIG. 26A is a diagram illustrating an example of generating an active music video based on an active appreciation file according to various embodiments.

FIG. 26B is a diagram illustrating another example of generating an active music video based on an active appreciation file according to various embodiments.

FIG. 27 is a flowchart illustrating an example of an operation method of an electronic device for generating an active experience item according to various embodiments.

FIG. 28 is a diagram illustrating an example of an operation of generating an active experience item using an authoring module according to various embodiments.

FIG. 29 is a diagram illustrating an example of using an active experience item according to various embodiments.

FIG. 30 is a flowchart illustrating an example of an operation method of an electronic device for generating a digital album object according to various embodiments.

FIG. 31 is a diagram illustrating an example of an operation of generating a digital album object using an authoring module according to various embodiments.

FIG. 32 is a diagram illustrating an example of using a star object according to various embodiments.

FIG. 33 is a flowchart illustrating an example of an operation method of an electronic device for generating an active learning object according to various embodiments.

FIG. 34 is a diagram illustrating an example of an operation of generating an active learning object using an authoring module according to various embodiments.

### DETAILED DESCRIPTION

It should be understood that the various embodiments of the present disclosure and the terms used herein are not intended to limit the technical features disclosed in the present disclosure to specific embodiments, but to include various changes, equivalents, or alternatives of the corresponding embodiments. With regard to the description of the drawings, similar reference numerals may be used for similar or related components. The singular form of a noun corresponding to an item may include one or more of the items unless the relevant context clearly indicates otherwise. In the present document, each of the phrases such as “a or b”, “at least one of a and b”, “at least one of a or b”, “a, b, or c”, “at least one of a, b, and c,” and “a, b, or c,” may include any one of the items listed together in the corresponding phrase, or any combination of them. The terms such as “first,” “second,” or “first,” or “second,” may be used to simply distinguish the corresponding component from other corresponding components, and do not limit the corresponding components in other aspects (e.g., importance or order). When an (e.g., first) component is referred to as “coupled” or “connected” together with or without the term “functionally” or “communicatively” to another (e.g., second) component, it means that the said component may be connected to the other component directly (e.g., wiredly), wirelessly, or through a third component.

The term “module” used in various embodiments of the present disclosure may include a unit implemented in hardware, software, or firmware, and may be used interchangeably with the terms such as logic, logical block, part, or circuit. The module may be an integrated component or a minimum unit of the component or a part thereof that performs one or more functions. For example, according to an embodiment, the module may be implemented in the form of an application-specific integrated circuit (ASIC).

Various embodiments of the present disclosure may be implemented as software (e.g., a program) including one or more instructions stored in a storage medium (e.g., internal memory) or external memory that can be read by a machine (e.g., an electronic device). For example, the processor (e.g., processor) of the machine (e.g., an electronic device) may invoke at least one instruction among the one or more instructions stored from the storage medium and execute it. This enables the machine to operate to perform at least one function according to the at least one invoked instruction. The one or more instructions may include code generated by a compiler or code that can be executed by an interpreter. A storage medium that can be read by a machine may be provided in the form of a non-transitory storage medium. Here, the term “non-transitory” merely means a device that is tangible and does not include a signal (e.g., electromagnetic wave), and this does not separately store data from the storage medium.

According to an embodiment, the method may be included in a computer program product. The computer program product may be traded between a seller and a buyer as a product. The computer program product may be distributed in the form of a machine-readable storage medium (e.g., compact disc read only memory (CD-ROM)), or may be distributed (e.g., downloaded or uploaded) online through an application store (e.g., Play Store™), or directly between two user devices (e.g., smart phones). In the case of online distribution, at least a part of the computer program product may be temporarily stored or generated in a machine-readable storage medium such as a server of a manufacturer, a server of an application store, or a memory of a relay server.

According to various embodiments, each component (e.g., module or program) of the above-described components may include a single entity or a plurality of entities, and some of the plurality of entities may be separately arranged in other components. According to various embodiments, one or more components or operations among the above-described corresponding components may be omitted, or one or more other components or operations may be added. Alternatively, or additionally, a plurality of components (e.g., modules or programs) may be integrated into one component. In this case, the integrated component may perform one or more functions of each component of the plurality of components in the same or similar manner as that performed by the corresponding component among the plurality of components before the integration. According to various embodiments, operations performed by a module, a program, or another component may be executed sequentially, in parallel, repeatedly, or heuristically, one or more of the operations may be executed in a different order, omitted, or one or more other operations may be added.

According to various embodiments, as an operation method of a server, an operation method may include: obtaining an audio file and a graphic file; obtaining a plurality of audio sources and a plurality of visual sources based on at least one of the audio file or the graphic file; obtaining a plurality of processed audio sources based on changing characteristics of at least a part of the plurality of audio sources; obtaining a plurality of processed visual sources based on changing characteristics of at least a part of the plurality of visual sources; and generating at least one active experience file based on generating at least one first audio source selected from the plurality of processed audio sources, at least one first visual source selected from the plurality of processed visual sources, and a specific type of interaction selected by a user in a related form, wherein the electronic device of the user is set to provide the at least one first audio source and the at least one first visual source when the specific type of interaction is received based on the at least one active experience file.

According to various embodiments, the operation method may include: obtaining the plurality of audio files based on a separate audio file, wherein the audio file is recorded at a time in an environment where sound corresponding to the plurality of audio sources is provided.

According to various embodiments, the operation method may include: obtaining the plurality of visual sources files based on separate graphic files, wherein the graphic file is the 3D graphic file.

According to various embodiments, the plurality of visual sources may include at least one of at least one graphic object included in the 3D virtual space, or a visual effect.

According to various embodiments, when the type of the at least one active experience file is a first type: based on the reception of the interaction of the user of the specific type, the user device may be configured to provide the at least one first audio source and the at least one first visual source while the track being provided is maintained, and when the type of the at least one active experience file is a second type: based on the reception of the interaction of the user of the specific type, the user device may be configured to provide the at least one first audio source and the at least one first visual source while the track being provided is changed to another track.

According to various embodiments, based on the type of the audio file and the type of the graphic file, the at least one audio source provided and/or the at least one visual source provided may be implemented to be different.

According to various embodiments, the method may further include obtaining the 3D virtual space including the plurality of graphic sources, wherein the at least one active experience file may be configured to provide a first type of sound based on the reception of the interaction of the user of the specific type with respect to the at least one graphic source included in the 3D virtual space when the type of the audio file is a first type, and provide a second type of sound based on the reception of the interaction of the user of the specific type with respect to the at least one graphic source included in the 3D virtual space when the type of the audio file is a second type.

According to various embodiments, the method may further include obtaining the 3D virtual space including the plurality of graphic sources, wherein the at least one active experience file may be configured to provide a specific sound based on the reception of the interaction of the user of the specific type with respect to the first type of graphic source included in the 3D virtual space when the type of the graphic file is a first type, and provide a specific sound based on the reception of the interaction of the user of the specific type with respect to the second type of graphic source included in the 3D virtual space when the type of the audio file is a second type.

According to various embodiments, the method may further include obtaining at least one file from a user; obtaining a prompt based on the at least one file; and obtaining at least one media context indicating characteristics of audio and characteristics of video based on the prompt and at least one AI model, and obtaining at least one audio source and at least one visual source based on the at least one media context.

According to various embodiments, the method may further include generating a file storing the obtained at least one audio source and the at least one visual source in a related form using the at least one AI model.

According to various embodiments, there may be provided an operating method including: identifying an event associated with the active experience file, wherein the event is an event for a specific visual source in the file and a specific audio source configured to be associated with the specific visual source, and including: identifying event time information associated with a time at which the event occurs; identifying audio specification information and graphic specification information of the electronic device; and providing the event based on the specific visual source and the specific audio source based on the event time information, the audio specification information, and the graphic specification information.

According to various embodiments, there may be provided an operating method in which event time information associated with a time at which the event occurs is associated with a musical unit.

According to various embodiments, there may be provided an electronic device including: at least one processor, wherein the at least one processor is configured to: acquire an audio file and a graphic file, acquire a plurality of audio sources and a plurality of visual sources based on at least one of the audio file or the graphic file, acquire a plurality of processed audio sources based on changing characteristics of at least some of the plurality of audio sources, acquire a plurality of processed visual sources based on changing characteristics of at least some of the plurality of visual sources, and generate at least one active experience file based on generating at least one first audio source selected from the plurality of processed audio sources, at least one first visual source selected from the plurality of processed visual sources, and a specific type of interaction selected by a user in a related form, and when the specific type of interaction is received based on the at least one active experience file, the user's electronic device is configured to provide the at least one first audio source and the at least one first visual source.

According to various embodiments, there may be provided an electronic device wherein the at least one processor is configured to: acquire the plurality of audio sources based on separation of the audio file, and wherein the audio file is a file recorded at once in an environment in which sound corresponding to the plurality of audio sources is provided.

According to various embodiments, there may be provided an electronic device wherein the at least one processor is configured to: acquire the plurality of visual sources based on separation of the graphic file, and wherein the graphic file is the 3D graphic file.

### 1. Active Music Experience System 1

According to various embodiments, the active music experience system 1 may be defined as a system implemented to provide (or perform) functions (or services) for experiencing music under user-led. Compared with a conventional music playing system implemented to simply provide a function of outputting sound by reproducing audio sources in a time series, a user can experience the active music provided by the interactive music experience system 1. Accordingly, the user may be able to more actively listen to music, deviating from the conventional music listening behavior of simply passively listening to music through the interactive music listening system 1, and the sense of immersion in the listening of music may be further increased. Examples of functions provided (or performed) by the interactive music listening system 1 will be described with reference to various embodiments below.

### 2. Components of the Active Music Experience System 1

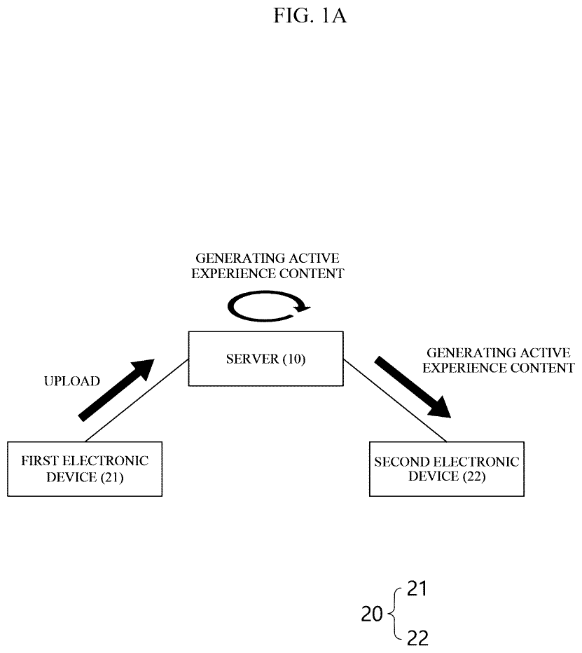

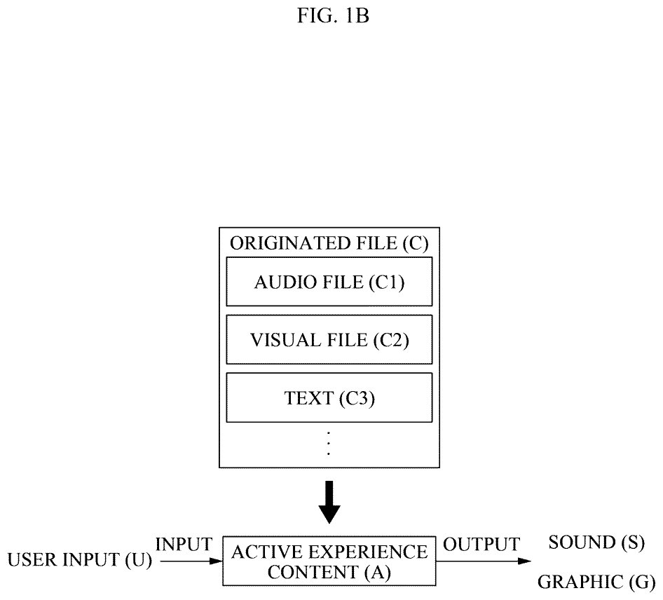

FIG. 1A is a diagram illustrating examples of components of the active music experience system 1 according to various embodiments. Hereinafter, FIG. 1A will be further described with reference to FIG. 1B.

FIG. 1B is a diagram for describing examples of active experience files according to various embodiments.

Referring to FIG. 1A, the active music experience system 1 according to various embodiments may include a server 10 and a user device 20. The server 10 and the user device 20 may all be defined as an “electronic device.”

According to various embodiments, the server 10 may be implemented to generate an active experience file A and provide the generated active experience file A. For example, referring to FIGS. 1A to 1B, the server 10 may generate the active experience file A based on an originated file C uploaded from the user device 20 (e.g., the first user device 21). The active experience file A may be provided in a form executable by the user device 20, and may be implemented as a file, an application including the file, or a computer program. The active experience file A may be implemented to output (or provide) sound S and graphics G corresponding to the user input U when the user input U is input while the active experience file A is executed by the user device 20. Meanwhile, the association of a specific sound S and a specific graphic G with a specific user input U may be defined as setting a specific rule. These rules may be present in plural, and the plurality of rules may be defined as a rule set. Accordingly, when a user input U of a type corresponding to each of the plurality of rules is received while the active experience file A is executed, sound S and graphics G corresponding to the user input U may be provided. Various embodiments for generating the active experience file A will be described in detail later. Meanwhile, the generation of the active experience file A may be performed based on an originated file C uploaded by the manager operating the server 10 rather than the user device 20.

According to various embodiments, the user device 20 may be an electronic device of a user for listening to music based on the active experience file A. The user device 20 may include a smartphone, tablet, PC, laptop, television, wearable device, head mounted display (HMD) device, etc. The user device 20 may include a first user device 20 a for generating an active experience file A based on uploading a specific originated file to the server 10 and a second user device 20 b for receiving and playing the active experience file A, but is not limited to the examples described, and one user device 20 may generate and appreciate the active experience file A.

### 2.1 Component of Electronic Device

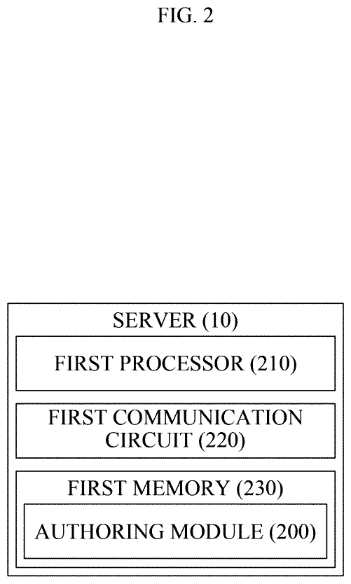

Hereinafter, an example of a configuration of each electronic device that configures the active music experience system 1 according to various embodiments will be described with reference to FIGS. 2 to 6.

### 2.1.1 Component of the Server 10

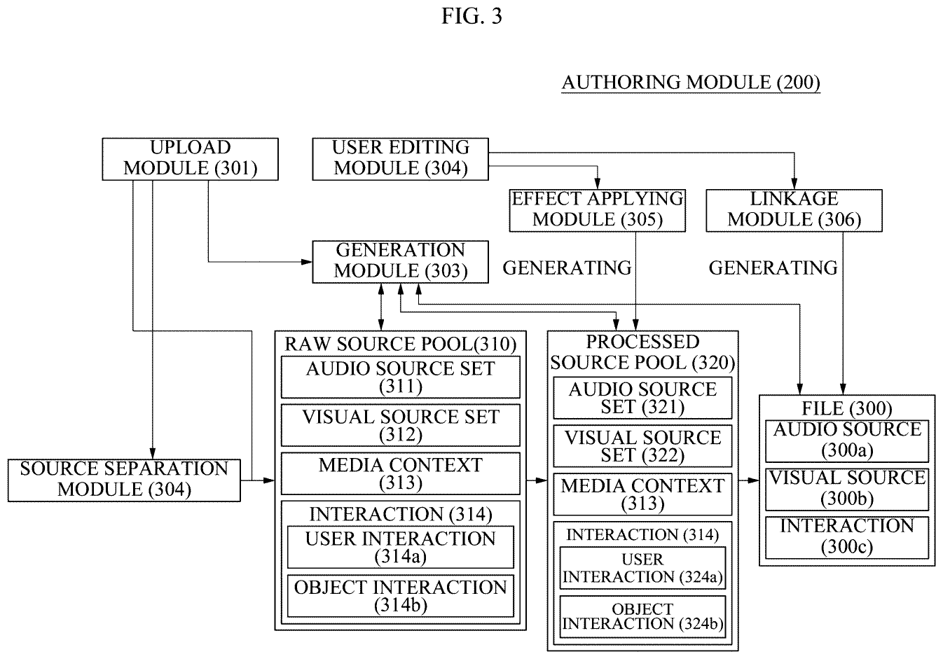

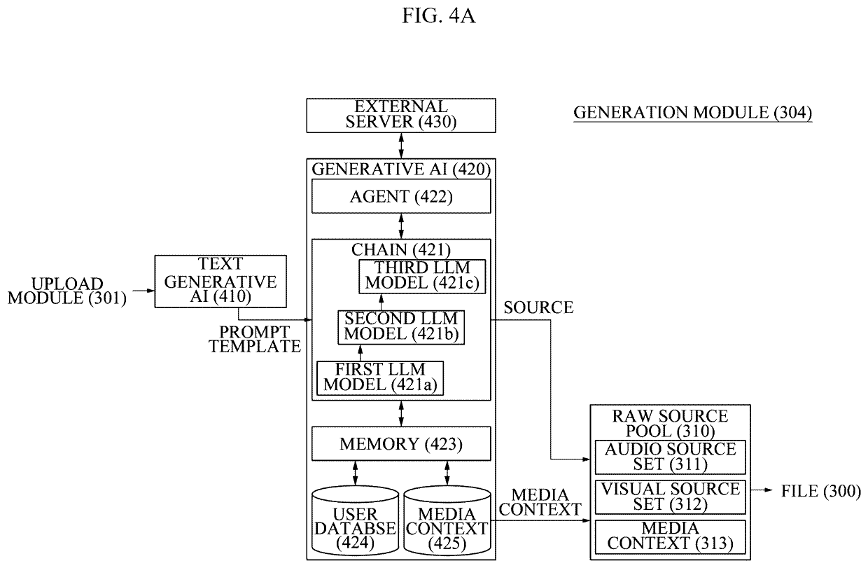

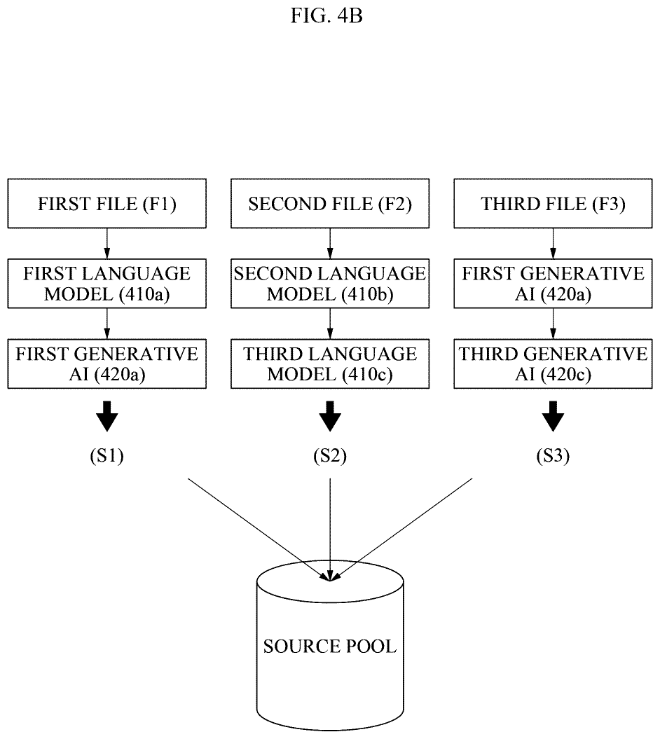

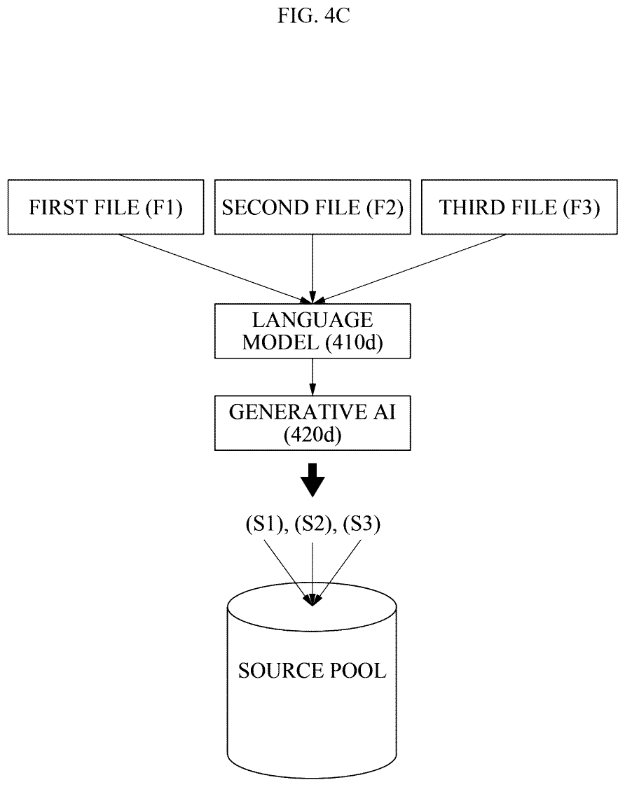

FIG. 2 is a block diagram illustrating an example of a component of the server 10 according to various embodiments. Hereinafter, FIG. 2 will be further described with reference to FIGS. 3 to 4.

FIG. 3 is a diagram illustrating an example of an authoring module 200 according to various embodiments. FIG. 4A is a diagram illustrating an example of a generation module 303 according to various embodiments. FIG. 4B is a diagram illustrating another example of the generation module 303 according to various embodiments. FIG. 4C is a diagram illustrating still another example of the generation module 303 according to various embodiments.

Referring to FIG. 2, the server 10 according to various embodiments may include a first processor 210, a first communication circuit 220, and a first memory 230 that stores the authoring module 200. However, the server 10 may include more configurations without being limited to the described and/or illustrated configurations.

According to various embodiments, the first processor 210 may control the overall operation of the server 10. To this end, the first processor 210 may perform calculation and processing of various pieces of information and control the operation of the components (e.g., the first communication circuit 220) of the server 10. According to an embodiment, as at least a part of the data processing or calculation, the first processor 210 may store a command or data received from another component in a volatile memory, process the command or data stored in the volatile memory, and store the resultant data in a non-volatile memory. According to an embodiment, the first processor 210 may include a main processor (not shown) (e.g., a central processing unit or an application processor) or an auxiliary processor (not shown) (e.g., a graphics processing unit, a neural network processing unit (NPU), an image signal processor, a sensor hub processor, or a communication processor) that is operable independently of or together with the main processor. For example, when the server 10 includes the main processor (not shown) and the auxiliary processor (not shown), the auxiliary processor (not shown) may be set to use lower power than the main processor (not shown) or be specialized to a specified function. The auxiliary processor (not shown) may be implemented separately from the main processor (not shown) or as a part thereof.

According to an embodiment of the present application, the auxiliary processor (not shown) may control at least a part of a function or states related to at least one component (e.g., the first communication circuit 220) among the main processor (not shown) while the main processor (not shown) is in an inactive (e.g., executing an application). According to an embodiment, the auxiliary processor (not shown) may be implemented as part of other components (e.g., the first communication circuit 220) functionally related to the other component (e.g., the first communication circuit 220). According to an embodiment, an auxiliary processor (not shown) (e.g., a neural network processing apparatus) may include a hardware structure specialized for processing an artificial intelligence model. The artificial intelligence model may be generated through machine learning. Such learning may be performed, for example, in the server 10 itself in which artificial intelligence is performed, or may be performed through a separate server (e.g., a learning server). The learning algorithm may include, for example, supervised learning, unsupervised learning, semi-supervised learning, or reinforcement learning, but is not limited to the above example. The artificial intelligence model may include a plurality of artificial neural network layers. The artificial neural network may be one of deep neural network (DNN), convolutional neural network (CNN), recurrent neural network (RNN), restricted boltzmann machine (RBM), deep belief network (DBN), bidirectional recurrent deep neural network (BRDNN), deep Q-networks, or a combination of two or more of the above, but is not limited to the above example. The artificial intelligence model may additionally or alternatively include a software structure in addition to the hardware structure.

Meanwhile, if there is no special mention in the following description, the operation of the server 10 may be interpreted as being performed by the control of the first processor 210.

According to various embodiments, the first communication circuit 220 may communicate with an external device (e.g., the user device 20). For example, the first communication circuit 220 may be connected to a network through wireless communication or wired communication to establish communication with an external device (e.g., the user device 20), and exchange information and/or data through the established communication. The wireless communication may include, for example, cellular communication using at least one of LTE, LTE-A (LTE Advance), CDMA (code division multiple access), WCDMA (wideband CDMA), UMTS (universal mobile telecommunications system), WiBro (Wireless Broadband), GSM (Global System for Mobile Communications), and the like. According to an embodiment, the wireless communication may include, for example, at least one of WiFi (wireless fidelity), Bluetooth, Bluetooth Low Energy (BLE), Zigbee, NFC (near field communication), Magnetic Secure Transmission, Radio Frequency (RF), or Body Area Network (BAN). According to an embodiment, the wireless communication may include gns. The GNSS may be, for example, a GPS (global positioning system), GNSS (Global Navigation Satellite System), Beidou Navigation Satellite System (hereinafter referred to as “Beidou”), or Galileo, the European global satellite-based navigation system. Hereinafter, in this document, “GPS” may be used interchangeably with “GNS. The wired communication may include, for example, at least one of universal serial bus (USB), high HDMI (high definition multimedia interface), RS-232 (recommended standard232), power line communication, or POTS (plain old telephone service). The network may include at least one of a telecommunication network, for example, a computer network (e.g., LAN or WAN), the Internet, or a telephone network.

According to an embodiment, the memory 230 may store various information. The memory 230 may temporarily or semi-permanently store data. For example, the memory 230 may store the authoring module 200 for generating the active experience file A. The server 10 (e.g., the first processor 210) may perform an operation for generating the active experience file A based on the authoring module 200.

According to various embodiments, referring to FIG. 3, the authoring module 200 may include an upload module 301, a source separation module 302, a generation module 303, a user editing module 304, an effect applying module 305, a linkage module 306, and a source pool 310, 320, and is not limited to the illustrated and/or described examples, and the authoring module 200 may be implemented to include more software configurations.

According to various embodiments, the upload module 301 may be implemented to acquire a music file and/or a graphic file uploaded by an electronic device (e.g., a manager of the server 10 and/or a user of the user device 20).

For example, the music file may correspond to a record stored to output sounds using a turntable to view music by a specific producer, a CD record stored to output sounds using a speaker connected to the computing device, audio data stored or generated in a sound wave form, audio data stored or generated in an analog-signal form, and audio data stored or generated in a digital-signal form, but is not limited thereto. The music file may be a file recorded at once in an environment in which sounds corresponding to the plurality of audio sources are provided. For example, the audio source included in the music file may correspond to audio data stored in a data format to which audio compression techniques are applied, such as MP3 and FLAC, but is not limited thereto.

For example, the audio source may include at least one specific stem file (or stem) having a corresponding (or similar) time length (or play length). The stem may include time series sound sources constituting a song, such as vocals, instruments (e.g., others, drums, pianos, symbols, plucks, turn-tables, kicks, and syns). Accordingly, when the music file is executed, mixed sounds may be provided as sounds based on each stem file are output during the same play time.

In this case, various types of musical units may be set (or identified) based on the audio source. For example, a musical meter may mean a unit for distinguishing and explaining music, and may include a beat, a bar, a motive, a small phrase, a large phrase, a period, and the like. The beat may mean a beat of a standard beat as a basic unit of time, and may be understood by a skilled technician. The bar may mean a musical unit including a standard burn number of an audio source, a minimum unit of a musical song divided by a column in a musical score, and may be understood as a bar that can be understood by a person skilled in the art. That is, different audio sources may have different musical units.

For example, the graphic file may include a graphic object, a map space, a visual effect, and text. For example, the graphic object may include various types of objects (e.g., rocks, buildings, pieces, moving plants, and the like), and other additional objects (e.g., floats), which are arranged in a character, a map space, and the like. In another example, the visual effect may include a particle effect, a visual characteristic (e.g., color, and the like) change effect of a map, lighting information, fog, and background effect, and the like.

According to various embodiments, the source separation module 302 may generate the raw source pool 310 by separating at least some of the files (e.g., music files, graphic files) uploaded by the electronic device (e.g., the manager of the server 10 and/or the user of the user device 20). The raw source pool 310 may include an audio source set 311 including a plurality of audio sources, a visual source set 312 including a plurality of visual sources, a media context 313, and an interaction 314 including a user interaction 314a and an object interaction 314b. Meanwhile, the source already separated by the electronic device may be uploaded to the server 10 without separating the files using the source separation module 302.

For example, as described above, the audio source set 311 may include time series sound sources constituting a song such as vocals, instruments (e.g., others, drums, pianos, symbols, plucks, turn-tables, kicks), and the like.

For example, the visual source set 312 may include the above-described graphic object, map space, visual effect, and text.

For example, the media context 313 may include information on the genre and atmosphere of the media.

For example, the interaction 314 may mean various types of interactions that can be received through the user device 20 while the generated file 300 (e.g., active experience file) is reproduced. For example, the user interaction 314a may include inputs that can be received through a touch screen such as a single touch, multi-touch, and drag, and inputs that can be received by sensors (e.g., tilt sensors, angular velocity sensors, and motion sensors) of the electronic device. In another example, the object interaction 314b may mean interactions between the visual source sets 312 based on the user interaction 314a. The interaction may mean a graphic event s such as visual source sets 312 contact each other (e.g., graphic objects contact each other), positioned within a predetermined distance, or placing graphic objects at a specific position. Meanwhile, although not illustrated, a camera viewpoint set for a graphic element based on the user interaction 314a may also be defined as the interaction 314. Accordingly, as the camera viewpoint changes, a source set connected thereto may be provided.

According to various embodiments, the source separation module 302 may include a model trained for source separation based on at least one of machine learning, artificial neural network, or deep neural network, but is not limited to the described example.

According to various embodiments, the generation module 303 may be implemented to generate the source pool 310 and 320 based on a language model using a lang chain. For example, referring to FIG. 4A, the generation module 303 may include a text generative AI 410 and a generative AI 420 for generating a source based on text generated by the text generative AI 410.

For example, the text generative AI 410 may be an AI model implemented to generate text based on a file (e.g., music file, graphic file, text) uploaded through the upload module 310. For example, the text generative AI 410 may be implemented to output text for describing a specific image based on a specific image being uploaded by a user. For example, when a photo including sun and cloud is uploaded, the text generative AI 410 may output text for describing an image such as “a cloudy sky with single bright light”.

For example, the generative ai 420 may be an AI model trained to generate a media context 425 based on text input from the text generative AI 410 and generate at least one of an audio source or a visual source based on a text prompt including the generated media context 425. The media context 425 is a predetermined text and may include a music context for describing a musical property and a graphic context for describing a visual property of a graphic. For example, when a text for describing an image such as “a cloudy sky with single bright light” is input, a text for describing a predetermined BPM value and a predetermined atmosphere may be obtained as the media context 425 based on a plurality of language models (e.g., a lang chain 421). The generative ai 420 may be implemented as a result of learning by inputting a text prompt including text generated by the plurality of language models described above and outputting an audio source and/or a visual source corresponding thereto. Meanwhile, the sources output from the generative ai 420 may be raw source pool 310, but may be a source pool to which effects are applied.

The generative AI 420 may include a lang chain 421 including a plurality of language models 421a, 421b, 421c, an agent 422, a memory 423, a user database 424, and a media context 425. The lang chain 421 may generate a media text for describing music based on text received from the text generative AI 410. In this case, the media context 425 may be stored in the memory 423. In addition, the plurality of language models 421a, 421b, and 421c may generate the media context 425 by referring to information (e.g., age, preference, and the like) related to the user stored in the user database 424. In addition, the plurality of language models 421a, 421b, and 421c may generate the media context 425 by referring to information collected from the external server 430 through the agent 422.

According to various embodiments, the generation module 303 may be implemented to apply the effect on the generated source (e.g., audio source, visual source). For example, although not shown, the generation module 303 may continuously upload a file from a user, and thus may apply the effect on the generated source (e.g., audio source, visual source).

According to various embodiments, the generation module 303 may be implemented to generate the file 300 by connecting the generated source (e.g., audio source, visual source).

According to various embodiments, the user editing module 304 may be implemented to access the server 10 to receive the user's control (i.e., the user's input) of the user device 20 using the authoring module 200. The user editing module 304 may provide additional input to the generation module 303, provide an effect application command to the sources stored in the source pool 310 to the effect application module 305, and provide an input for selecting the generated sources from the file 300 to the linkage module 306.

According to various embodiments, the effect application module 305 may be implemented to generate the processed source pool 320 by applying the effect to each of the sources in the raw source pool 310. For example, the effect application module 305 may change the attribute of the audio source set 311 stored in the raw source pool 310 and/or edit the attribute of the visual source set 312 stored in the raw source pool 310 based on the user's control received through the user editing module 304.

According to various embodiments, the linkage module 306 may generate the file 300 (i.e., the active experience file) including the sources selected by the user from the processed source pool 320 through the user editing module 304. The file 300 may include information about the audio source 300a, the visual source 300b, and the interaction 300c stored in a related form. Accordingly, while the file 300 is reproduced by the user device 20, the audio source 300a and the visual source 300b may be provided (or reproduced) together when the interaction corresponding to the interaction 300c is received by the user device 20.

According to various embodiments, the file 300 (e.g., the active experience file) may be implemented in a track unit that moves to a clip unit and/or another track that can be reproduced from one track. For example, when the file 300 (e.g., the active experience file) is generated in a clip unit, the file 300 (e.g., the active experience file) may be set to provide the at least one first audio source and the at least one first visual source in a state that the track being provided is maintained. For example, in the metaverse music experience content described below, a certain motion may be taken according to the user input while characters are located in a certain space based on the clip unit file. For example, when the file 300 (e.g., active experience file) is generated in units of tracks, the file 300 (e.g., active experience file) may be set to provide the at least one first audio source and the at least one first visual source while changing from the track being provided to another track. As an example, in the metaverse music experience content described below, a specific motion may be taken according to a user input and additional sound may be provided while moving a character located in a specific space to another space based on the file in the track unit, while reproducing music corresponding to another space.

According to various embodiments, the generation module 303 may be implemented to include a language model that receives files (e.g., the first file f1, the second file f2, and the third file f3) and outputs text, and a generative ai.

In an embodiment, referring to FIG. 4B, the generation module 303 may include a plurality of generative AIs (e.g., the first generative AI 420a, the second generative AI 420b, and the third generative AI 420c) implemented to output different types of sources (e.g., the first source S1, the second source S2, and the third source S3), and include a plurality of language models (e.g., the first language model 410a, the second language model 410b, and the third language model 410c) for outputting text to each of the plurality of generative AIs (e.g., the first generative AI 420a, the second generative AI 420b, and the third generative AI 420c).

For example, each of the plurality of language models (e.g., the first language model 410a, the second language model 410b, and the third language model 410c) may generate text for generating a specific type of source based on receiving files (e.g., the first file F1, the second file F2, and the third file F3). The type of the source may include a 3D graphic object (or model), a music file, an avatar, and the like. Each of the plurality of generative AIs may generate and provide a source based on text provided from the language model (e.g., the first language model 410a, the second language model 410b, and the third language model 410c).

In another embodiment, referring to FIG. 4C, the generation module 303 may include a single language model 410c and a single generative AI 420c. Accordingly, the single language model 410c may output texts based on receiving a plurality of files (e.g., the first file F1, the second file F2, and the third file F3), and the single generative AI 420c may generate and output various types of sources based on the texts.

### 2.1.2 Components of the User Device 20

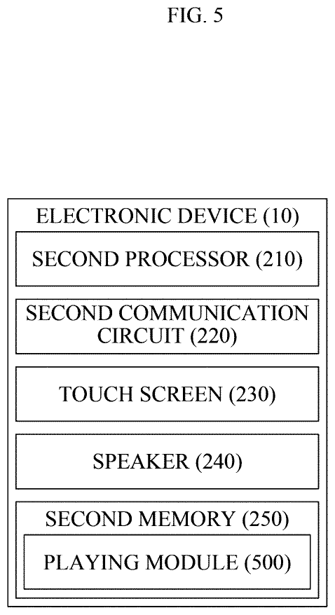

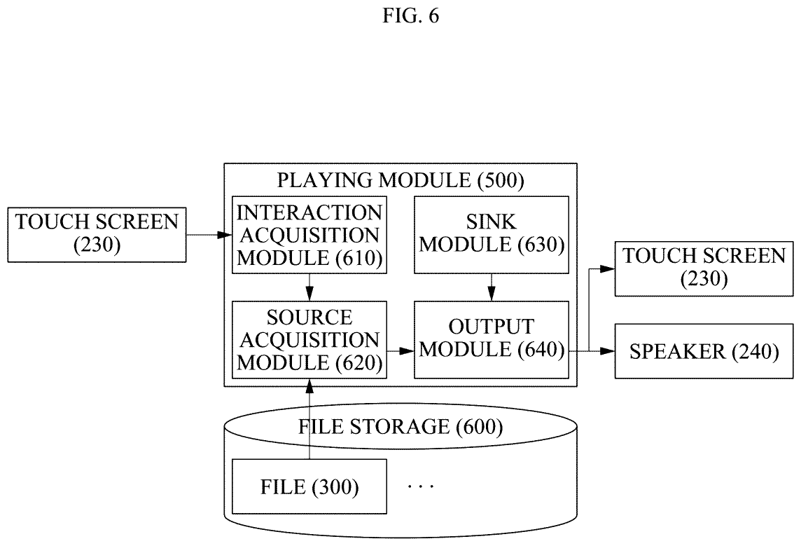

FIG. 5 is a block diagram illustrating an example of components of the user device 20 according to various embodiments. Hereinafter, FIG. 5 will be further described with reference to FIG. 6.

FIG. 6 is a diagram for describing an example of a reproduction module 500 according to various embodiments.

According to various embodiments, referring to FIG. 5, the user device 20 may include a second processor 510, a second communication circuit 520, a touch screen 530, a speaker 540, and a second memory 550. The second processor 510 may be implemented like the first processor 210, the second communication circuit 520 may be implemented like the first communication circuit 220, and the second memory 550 may be implemented like the first memory 230, and thus redundant descriptions will be omitted.

According to various embodiments, the touch screen 530 may be implemented to display visual content based on a visual source and receive a user input. For example, the second processor 510 may display a visual source corresponding to the touch screen 530 while reproducing the file 300. Since the touch screen 530 is a well-known technology, detailed description will be omitted.

According to various embodiments, the speaker 540 may output sound based on an audio source. For example, the second processor 510 may output sound through the speaker 540 based on an audio source corresponding to the audio source when a user input is received through the touch screen 530 while reproducing the file 300. Since the speaker 540 is a well-known technology, detailed descriptions will be omitted.

According to various embodiments, the user device 20 (e.g., the second processor 510) may be configured to reproduce the above-described file 300 (e.g., an active experience file) based on the reproduction module 500 stored in the second memory 550. For example, referring to FIG. 6, the reproduction module 500 may include an interaction acquisition module 610, a source acquisition module 620, a sink module 630, and an output module 640.

For example, the interaction acquisition module 610 may be implemented to acquire a user input received from the touch screen 230.

For example, the source acquisition module 620 may be implemented to acquire at least one audio source and at least one visual source in a specific file corresponding to the acquired user input among a plurality of files 300 stored in the file storage 600.

For example, the sink module 630 may be implemented to synchronize the acquired at least one audio source and the reproduction time of the at least one visual source.

For example, the output module 640 may display a graphic object through the touch screen 230 based on the visual source and output sound through the speaker 240 based on the audio source.

### 2.1.3 Implementation Examples of the Authoring Module 300 and the Reproduction Module 500

The above-described authoring module 300 and the reproduction module 500 are not limited to the described and/or illustrated examples, and may be installed in the server 10 or in the user device 20.

When the user device 20 is installed in the server 10, the user device 20 may access the server 10 to generate and reproduce an active experience file based on the authoring module 300 and the reproduction module 500 installed in the server 10.

When the user device 20 is installed in the server 10, the user device 20 may generate and reproduce an active experience file based on the authoring module 300 and the reproduction module 500 installed in the user device 20 without accessing the server 10.

Hereinafter, for convenience of description, the electronic device (e.g., the server 10 and the user device 20) is described assuming that the authoring module 300 and the reproduction module 500 are installed in the electronic device (e.g., the user device 20) and the electronic device described below may be understood as the server 10 and/or the user device 20.

### 3. Operation Method for Generating and Reproducing an Active Experience File

### 3.1. Operation Method for Generating an Active Experience File

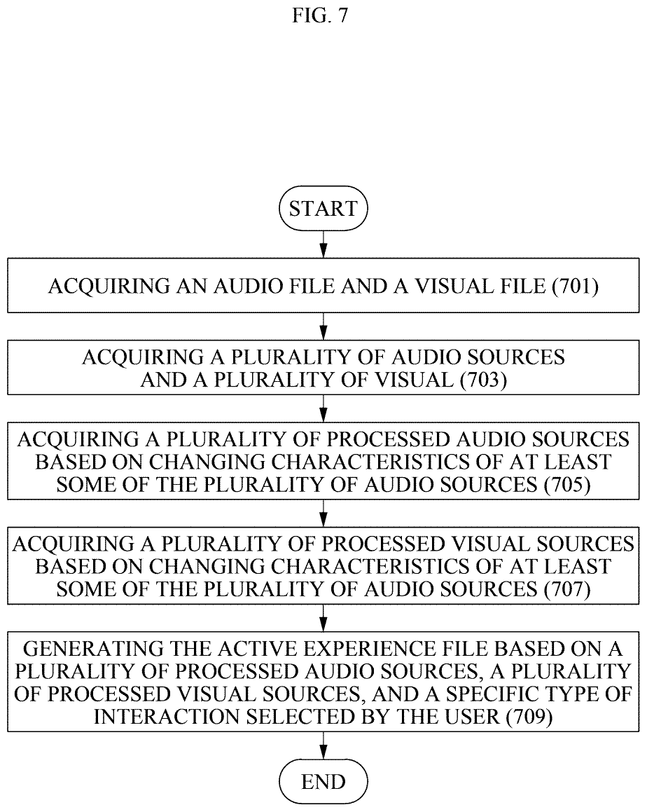

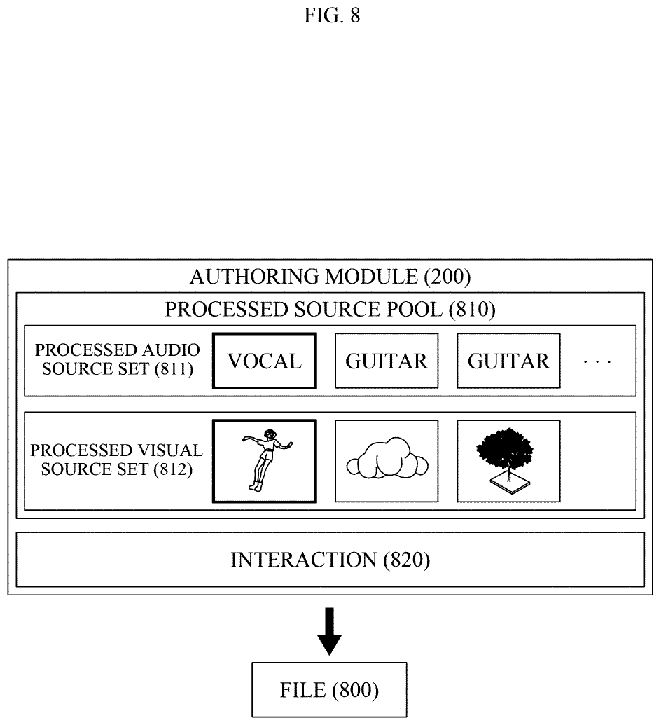

FIG. 7 is a flowchart illustrating an example of an operation method of an electronic device (e.g., the server 10 and the user device 20) for generating an active experience file according to various embodiments. However, operations may be performed in a different order than the described and/or illustrated operations, and may be perform more or less operations than the described and/or illustrated operations. Hereinafter, FIG. 7 will be described with reference to FIG. 8.

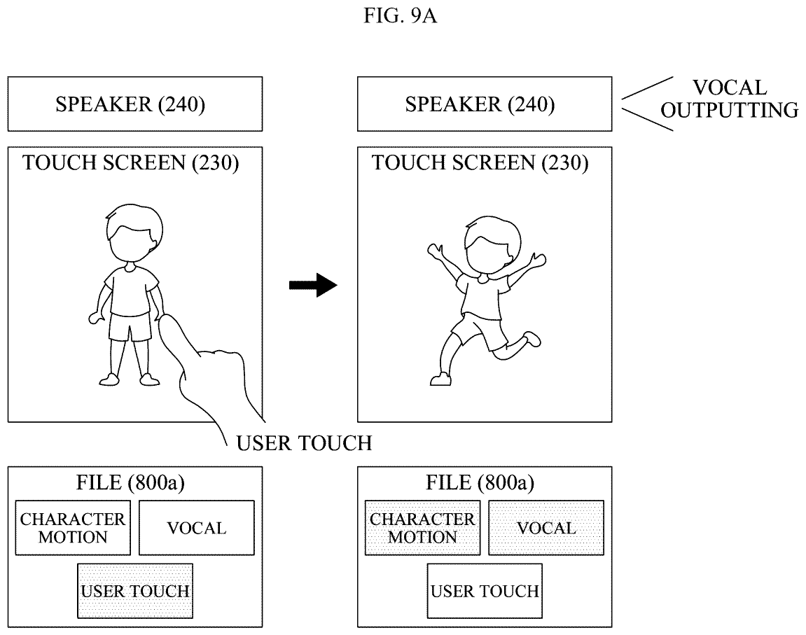

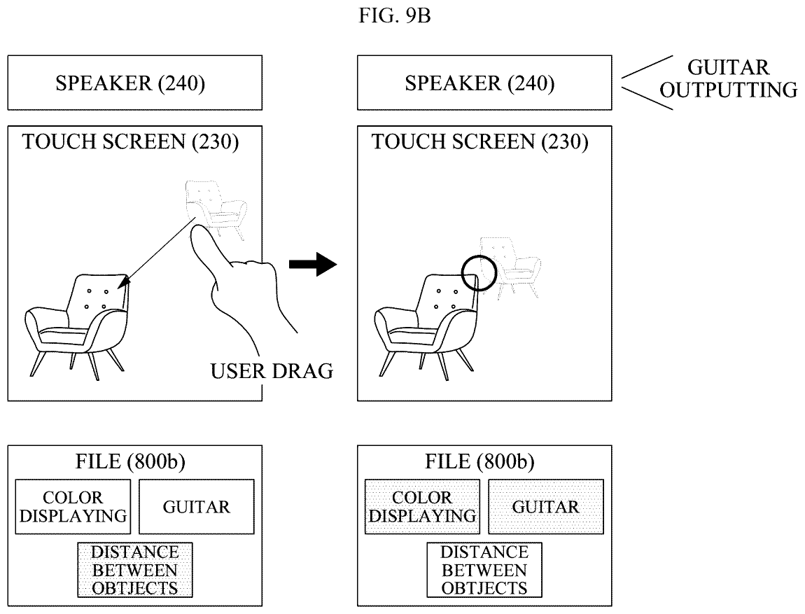

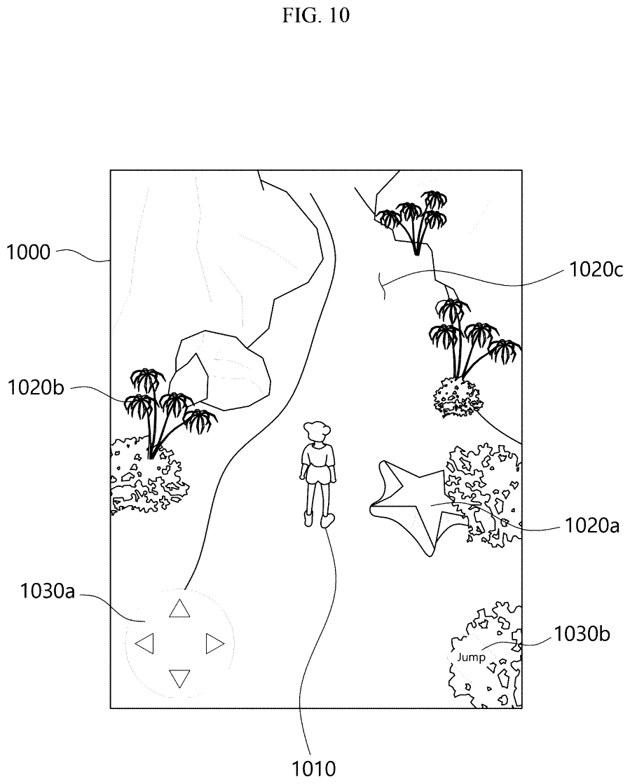

FIG. 8 is a diagram illustrating an example of an operation for generating an active experience file 800 using an authoring module 200 of an electronic device according to various embodiments. FIG. 9A is a diagram illustrating an example of an active experience file 800 played based on a user input, according to various embodiments. FIG. 9B is a diagram illustrating an example of an active experience file 800 played based on an object interaction, according to various embodiments. FIG. 10 is a diagram illustrating an example of content played based on an active experience file 800, according to various embodiments.

According to various embodiments, the electronic device (e.g., the server 10 and the user device 20) may acquire an audio file and a visual file in operation 701, acquire a plurality of audio sources and a plurality of visual sources in operation 703, acquire a plurality of processed audio sources based on changing characteristics of at least some of the plurality of audio sources in operation 705, and acquire a plurality of processed visual sources based on changing characteristics of at least some of the plurality of audio sources in operation 707. For example, as described above, the electronic device (e.g., the server 10 and the user device 20) may acquire an audio file (or a music file) including a plurality of audio sources, and a visual file including a plurality of visual sources, based on the authoring module 200 (e.g., the upload module 301). The electronic device (e.g., the server 10 and the user device 20) may separate a plurality of audio sources from the audio file based on the authoring module 200 (e.g., the source separation module 302), and may separate a plurality of visual sources from the visual file. The audio source may include time series sound sources constituting a song, such as a vocal, a musical instrument (e.g., other, drum, piano, cymbal, pluck, turn-table, kick), and the like, as described above. The visual source may include a graphic object, a map space, a visual effect, and text. The electronic device (e.g., the server 10 and the user device 20) may acquire a source pool 810 processed (or the effect applied) as illustrated in FIG. 8 by applying the effect to at least some of the acquired plurality of audio sources or the acquired plurality of visual sources based on the authoring module 200 (e.g., the effect applying module 305).

According to various embodiments, the electronic device (e.g., the server 10 and the user device 20) may generate the active experience file 800 based on a plurality of processed audio sources, a plurality of processed visual sources, and a specific type of interaction selected by the user in operation 709. For example, referring to FIG. 8, the electronic device (e.g., the server 10 and the user device 20) may provide the processed source pool 810 to the user of the authoring module 200 using the user editing module 303, receive a user input for selecting a specific audio source from the processed audio source set 811, receive a user input for selecting a specific visual source from the processed visual source set 812, and receive an input for the type of interaction 820 associated with the processed audio source set 811. The electronic device (e.g., the server 10 and the user device 20) may generate the file 800 including the selected audio source, the selected visual source, and the specific interaction in a related form by using the linkage module 306.

According to various embodiments, the interaction may include at least one of a user input or object interaction. Referring to FIG. 9A, the active experience file 800a generated by the authoring module 200 may store an audio source (e.g., vocal), a visual source (e.g., character motion), and a user touch in a related form as an interaction. The user device 20 (e.g., the second processor 510) may display a graphical user interface including characters on the touch screen 230 while the file 800a is executed, and when a user touch is input through the touch screen 230, the character to which character motion is applied may be displayed on the touch screen 230 while outputting sound corresponding to the vocal through the speaker 240. Referring to FIG. 9B, the active experience file 800b generated by the authoring module 200 may store an audio source (e.g., others), a visual source (e.g., color display), and a distance between pre-set objects as an interaction in a related form. The user device 20 (e.g., the second processor 510) may display a graphical user interface including a plurality of graphical objects on the touch screen 230 while the file 800b is executed, and when the distance between the graphical objects is changed within a pre-set distance by a user input through the touch screen 230, a specific color display may be displayed on the touch screen 230 as a visual effect while outputting sound corresponding to the others through the speaker 240.

According to various embodiments, the user device 20 may provide the above-described audio effect and visual effect based on the active experience file 800 while providing content for music experience. For example, referring to FIG. 10, the content for music experience may include metaverse music content 1000. The metaverse music content 1000 may be defined as a content provided with a user object (e.g., character 1010) corresponding to (or operable by) the user and a map space in which the user object can be inspected. The map space may include various objects of thing graphics 1020a and 1020b that can interact with the user object, and a path 1020c through which the user object can be moved. The objects of thing graphics 1020a and 1020b may be graphic objects generated by a visual source set separated from the visual file uploaded by the user. In other words, the map space may be configured by the visual source set uploaded by the user. Meanwhile, as a control object (e.g., a moving object 1030a, a jump object 1030b) for controlling the user object is provided together with the metaverse content 1000, the user can inspect the map space using the user object. At this time, the user device 20 may provide visual and auditory effects based on the interaction (e.g., user interaction, object interaction) received by the user based on the active experience file 800 generated while the metaverse music content 1000 is provided, thereby enjoying the music file more actively.

### 3.1.1. Creation of Different Active Experience Files Per Upload File

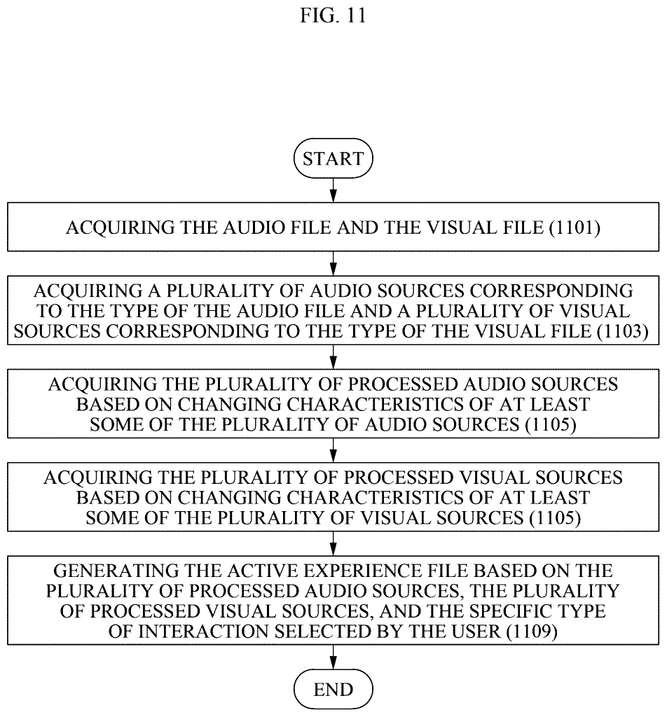

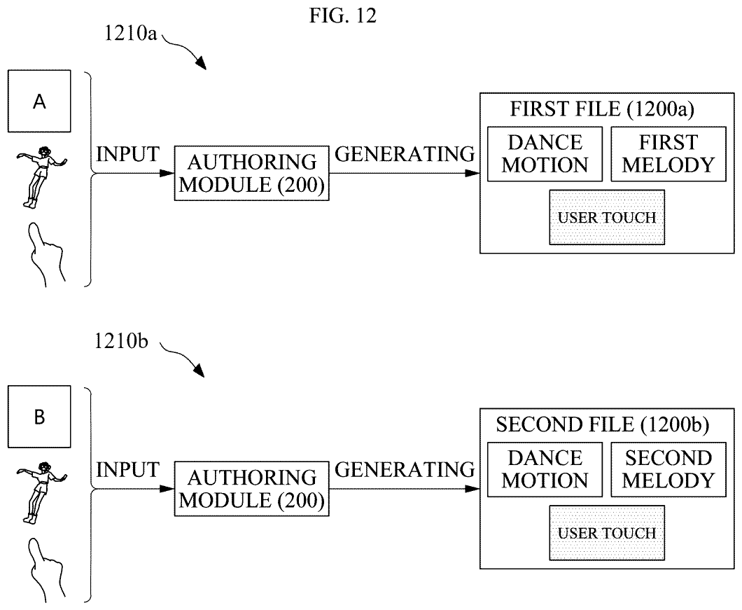

FIG. 11 is a flowchart illustrating an example of an operating method of an electronic device (e.g., a server 10 and a user device 20) for creating different active experience files per upload files, according to various embodiments. However, operations may be performed in an order different from the order of the described and/or illustrated operations, and more or fewer operations may be performed than the described and/or illustrated operations. Hereinafter, FIG. 11 will be further described with reference to FIG. 12.

FIG. 12 is a diagram for describing an example of an active experience file generated based on different files according to various embodiments.

According to various embodiments, the electronic device (e.g., the server 10 and the user device 20) may acquire the audio file and the visual file in operation 1101, and acquire a plurality of audio sources corresponding to the type of the audio file and a plurality of visual sources corresponding to the type of the visual file in operation 1103. For example, referring to FIG. 12, the electronic device (e.g., the server 10 and the user device 20) may generate different active experience files (e.g., the first file 1200a and the second file 1200b) according to the type of the uploaded audio file and the type of the visual file. As the audio source and the visual source included in the file uploaded to the authoring module 300 are different from each other, the resultant active experience files may be generated from the sources being different from each other, and the type of the source provided in response to the user interaction may be determined according to the type of the uploaded file. For example, referring to 1210a of FIG. 12, the first file 1200a generated by uploading the first music file may be implemented to output the first melody corresponding to the first music file when the user touch is input. For example, referring to 1210b of FIG. 12, the second file 1200b generated by uploading the second music file may be implemented to output the second melody corresponding to the second music file when the user touch is input. Accordingly, the user may easily generate the active experience file for each music file to be experienced using the authoring module 200.

According to various embodiments, the electronic device (e.g., the server 10 and the user device 20) may acquire the plurality of processed audio sources based on changing characteristics of at least some of the plurality of audio sources in operation 1105, acquire the plurality of processed visual sources based on changing characteristics of at least some of the plurality of visual sources in operation 1107, and generate the active experience file based on the plurality of processed audio sources, the plurality of processed visual sources, and the specific type of interaction selected by the user in operation 1109. Operations 1105 to 1109 of the electronic device (e.g., the server 10 and the user device 20) may be performed as operations 705 to 709 of the electronic device (e.g., the server 10 and the user device 20) described above, and thus redundant descriptions will be omitted.

### 3.2 Generation Module 303-Based Source Generation

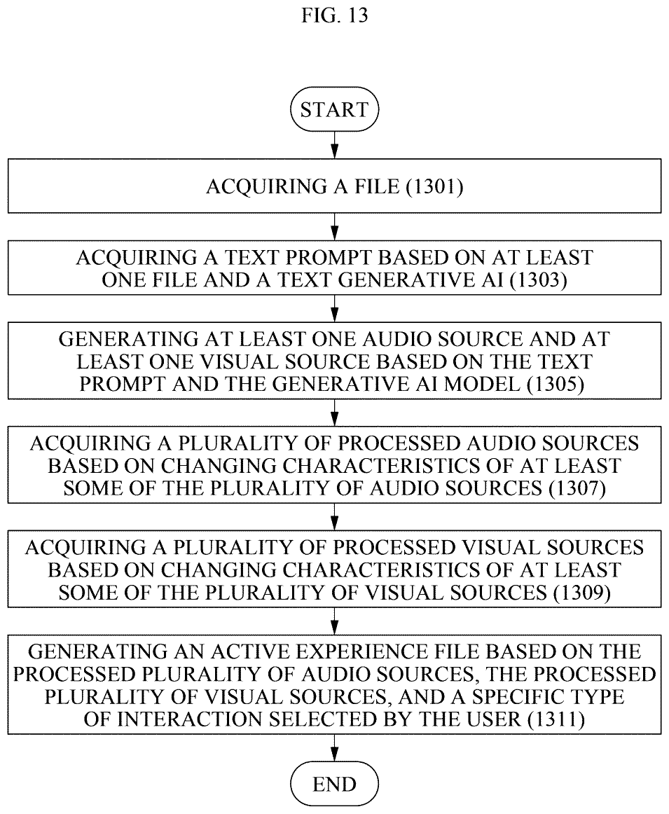

FIG. 13 is a flowchart illustrating an example of an operating method of an electronic device (e.g., the server 10 and the user device 20) for generating a source based on the generation module 303 according to various embodiments. However, operations may be performed in an order different from the order of the described and/or illustrated operations, and more or fewer operations may be performed than the described and/or illustrated operations.

According to various embodiments, the electronic device (e.g., the server 10 or the user device 20) may acquire a file (e.g., an audio file and/or a visual file) in operation 1301.

According to various embodiments, the electronic device (e.g., the server 10 or the user device 20) may acquire a text prompt based on at least one file and a text generative AI in operation 1303, and may generate at least one audio source and at least one visual source based on the text prompt and the generative AI model in operation 1305. For example, the electronic device (e.g., the server 10 or the user device 20) may generate a plurality of sources based on the above-described generation module 303. For example, the electronic device (e.g., the server 10 or the user device 20) may generate text for describing the uploaded file (e.g., an image) using the text generative AI 410 implemented to generate text based on a file (e.g., a music file, a graphic file, or a text) uploaded through the upload module 310. The electronic device (e.g., the server 10 or the user device 20) may generate the media context 425 when text for describing the uploaded file (e.g., an image) is input based on a plurality of language models (e.g., the rank chain 421), and may generate the audio source and/or the visual source as a result based on the input of the text prompt including the generated media context 425 to the generative ai 420.

According to various embodiments, the electronic device (e.g., the server 10 or the user device 20) may acquire a plurality of processed audio sources based on changing characteristics of at least some of the plurality of audio sources in operation 1307, acquire a plurality of processed visual sources based on changing characteristics of at least some of the plurality of visual sources in operation 1309, and generate an active experience file based on the processed plurality of audio sources, the processed plurality of visual sources, and a specific type of interaction selected by the user in operation 1311. Operations 1307 to 1311 of the electronic device (e.g., the server 10 or the user device 20) may be performed like operations 705 to 709 of the electronic device (e.g., the server 10 or the user device 20) described above, and thus redundant descriptions will be omitted. The electronic device (e.g., the server 10 or the user device 20) may apply an effect to a source (e.g., an audio source and a visual source) generated based on input received from the user based on the generation module 300, and generate an active experience file including interactions with the sources (e.g., the audio source and the visual source) to which the effect is applied in association with each other. For example, after the generation module 303 generates the source as described above, the generation module 303 may apply the effect to the sources and/or generate the active experience file based on the reception of the text prompt from the user using the authoring module 200. For example, the text prompt may include a text prompt for applying the effect and/or a text prompt for selecting some of the sources to which the effect is applied (or processed) and generating the active experience file in association with a specific type of user interaction. In this case, the text prompt may be generated based on the text generative AI 410 as described above.

On the other hand, the presented example is not limited, and rather than generating a text prompt after the generation of a source (e.g., an audio source and a visual source), the generation module 303 may be implemented to perform an operation of generating a source, an operation of applying an effect to the generated source, and an operation of generating a rural experience file when the text prompt is input in operation 1305 to generate the active experience file as a result.

### 3.3. Reproduction of the Active Experience File Based on the Playing Module 500

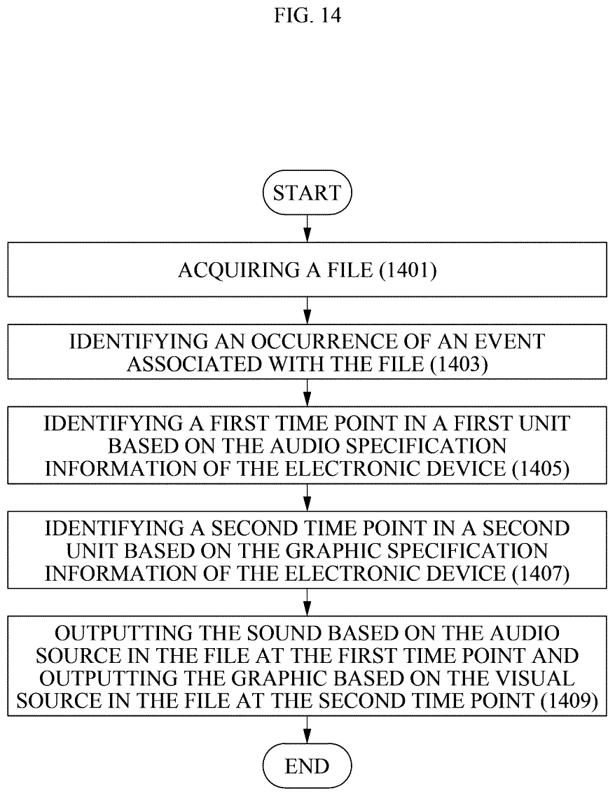

FIG. 14 is a flowchart illustrating an example of an operation method of an electronic device (e.g., a server 10 or a user device 20) for reproducing the active experience file based on the playing module 500 according to various embodiments. However, operations may be performed in an order different from the order of the described and/or illustrated operations, and more or fewer operations may be performed than the described and/or illustrated operations.

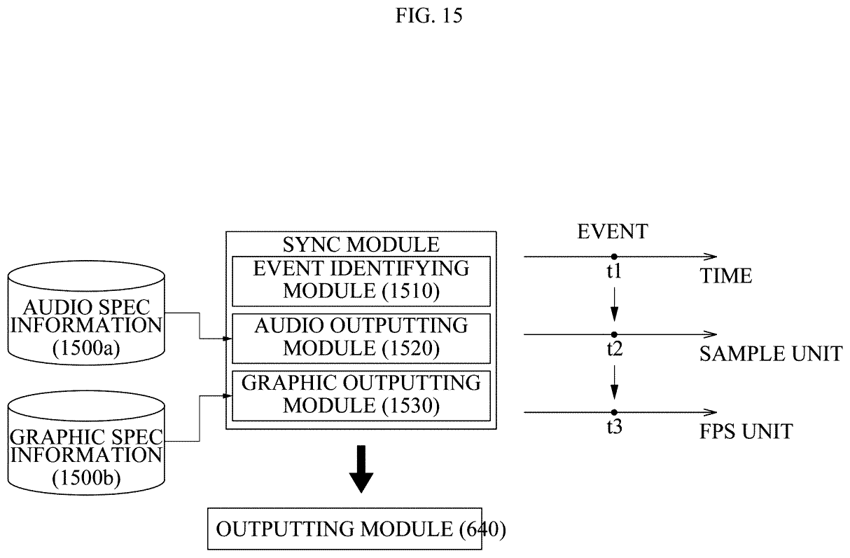

FIG. 15 is a diagram illustrating an example of an operation of synchronizing a playback time point between an audio source and a visual source using the sink module 630 according to various embodiments.

According to various embodiments, the electronic device (e.g., the server 10 or the user device 20) may acquire a file (e.g., an active experience file) in operation 1401, and identify an occurrence of an event associated with the file (e.g., the active experience file) in operation 1403. For example, the active experience file may include at least one audio source, at least one visual source, and a user interaction in a form associated with each other, as described above. In this case, the event associated with the file (e.g., the active experience file) may be an event that triggers the provision of at least one audio source and at least one visual source included in the active experience file based on the active experience file. The event may include a first event in which the user interaction is received, and an audio event that triggers the reproduction of an audio source in the active experience file and a graphic event that triggers the reproduction of a visual source regardless of the reception of the user interaction. When the audio event occurs, the reproduction of the audio source based on the active experience file and the provision of the stored visual source to be associated with the audio source may be performed, and when the graphic event occurs, the reproduction of the visual source based on the active experience file and the provision of the stored audio source to be associated with the visual source may be performed. On the other hand, when the audio source and the visual source are provided together based on the occurrence of the event, the provision time of the audio source and the visual source actually experienced based on the different reproduction time units between the audio source and the visual source (i.e., the sink may not match). The sink module 630 of the playing module 500 may solve the problem by providing synchronization between the audio source and the visual source.

According to various embodiments, the electronic device (e.g., the server 10 or the user device 20) may identify a first time point in a first unit based on the audio specification information of the electronic device (e.g., the server 10 or the user device 20) in operation 1405, and may identify a second time point in a second unit based on the graphic specification information of the electronic device (e.g., the server 10 or the user device 20) in operation 1407. For example, referring to FIG. 15, the sink module 630 may include an event identification module 1510, an audio output module 1520, and a graphic output module 1530. When identifying the occurrence of an audio event or a graphic event based on the event identification module 1510, the electronic device (e.g., the server 10 or the user device 20) may identify a playback time point based on the audio source based on the audio output module 1520, and may identify a playback time point based on the visual source based on the graphic output module 1530.

In an embodiment, when the audio event causing the provision of a specific audio source at the first time point t1 is identified based on the information about the audio event, the electronic device (e.g., the server 10 or the user device 20) may identify the second time point t2 (e.g., a specific DSP time) in the first time unit (e.g., sample unit) at which the sound is to be played based on the audio source by referring to the audio specification information 1500a of the electronic device by using the audio output module 1520. The electronic device (e.g., the server 10 or the user device 20) may identify the visual source corresponding to the specific audio source in the active experience file, and may identify the third time point t3 (e.g., a specific frame number) corresponding to the second time point t2 in the second time unit (e.g., FPS unit) at which the graphic is to be output based on the visual source identified by referring to the graphic specification information 1500b of the electronic device by using the graphic output module 1530.

In another embodiment, when the graphic event causing the provision of a specific visual source at the first time point t1 is identified based on the information about the graphic event, the electronic device (e.g., the server 10 or the user device 20) may identify the third time point t3 (e.g., a specific frame number) in the second time unit (e.g., FPS unit) by using the graphic output module 1530, and may identify the second time point t2 (e.g., a specific DSP time) in the first time unit (e.g., sample unit) corresponding to the third time point t3 (e.g., a specific frame number) by using the audio output module 1520.

According to various embodiments, the electronic device (e.g., the server 10 or the user device 20) may output the sound based on the audio source in the file at the first time point (e.g., a specific sample t2 in the sample unit) and output the graphic based on the visual source in the file at the second time point (e.g., a specific frame t3 in the FPS unit) in operation 1409.

### 4. Metaverse Music Content Provision Operation

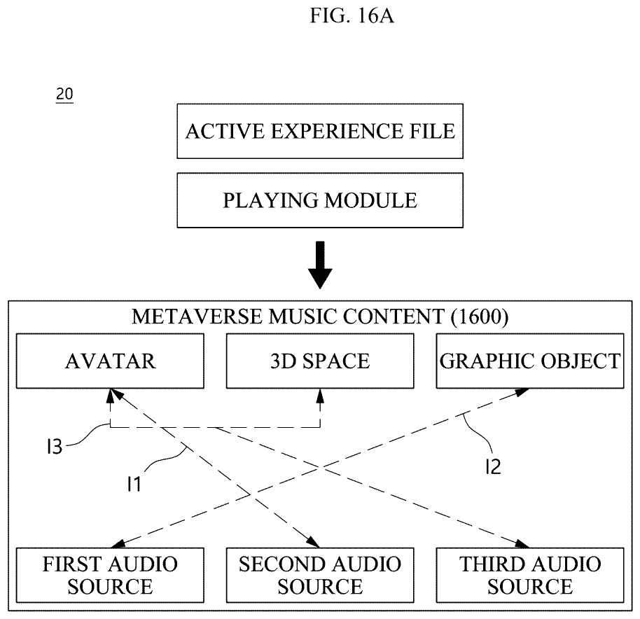

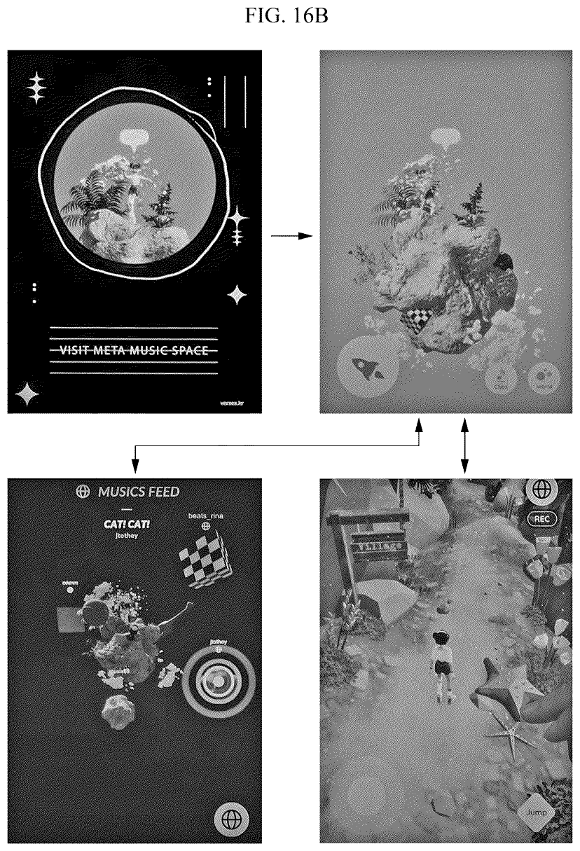

FIG. 16A is a diagram for explaining an example of an operation for providing the metaverse music content 1600 of the user device 20 according to various embodiments. FIG. 16B is a diagram for explaining an example of contents included in the metaverse music content 1600 according to various embodiments.

According to various embodiments, the user device 20 (e.g., the second processor 510) may provide the metaverse music content 1600 based on at least one visual source and at least one audio source included in the active viewing file based on the playing module 500 and at least one active viewing file. In other words, contents may be provided to actively view the specific music file called metaverse music content 1600 based on at least one active viewing file produced by the user. The metaverse music content 1600 may be contents including user objects (e.g., characters, avatars) corresponding to the user (or manipulatable by the user), and map spaces (or 3D spaces) including various types of visual sources (e.g., objects). The user object and the map space included in the metaverse music content 1600 may be visual sources included in the active appreciation file described above.

According to various embodiments, the user device 20 may output sound based on an audio source when a specific type of user interaction is input to a specific visual source based on the active appreciation file while providing the metaverse music content 1600. For example, based on the first active appreciation file i1, the user device 20 may output sound based on a second audio source when a user interaction is received in the avatar. For example, based on the second active appreciation file i2, the user device 20 may output sound based on a third audio source when an object interaction between the avatar and the 3D space is received. For example, based on the third active appreciation file i3, the user device 20 may output sound based on the first audio source when a user interaction with respect to a specific graphical object is received.

According to various embodiments, the metaverse music content 1600 may include various stages of content. For example, referring to FIG. 16B, the metaverse music content 1600 may include initial spatial content 1600a, standby spatial content 1600b, interaction spatial content 1600c, and expansion content 1600d.

For example, the initial spatial content 1600a may be generated in a form including at least a partial portion of the standby spatial content 1600b, the interaction spatial content 1600c, or the expansion content 1600d. For example, the initial spatial content 1600a may be generated by placing a cover having a partial area opened on at least one of the standby spatial content 1600b, the interaction spatial content 1600c, or the expansion content 1600d or by cropping a partial area, and may be generated in a 2D type or a 3D type. The generated initial spatial content 1600a may be edited by the user and may be shared to other users for the purpose of relax or album cover. When the initial spatial content 1600a is opened by the user input, the user device 20 may provide the standby spatial content 1600b.

For example, the standby spatial content 1600b may include a planet object editable by the user. The visual source obtained from the interaction spatial content 1600c may be added to the planet object. Based on the active appreciation file, an audio source associated with the visual source added to the planet object may be set, and whether the audio source is reproduced with respect to the visual source added to the planet object may be activated or deactivated. When the reproduction of the audio source with respect to the visual source is activated, the user device 20 may output sound based on the audio source corresponding thereto, and when the reproduction of the audio source of all visual sources is deactivated, only base music may be provided. The standby spatial content 1600b provides an SNS function capable of chatting with artists corresponding to the music file, and in this case the chatting function may be activated when an item such as a photocard is purchased. The user device 20 may switch from the standby the interaction spatial content 1600b to the interaction spatial content 1600c and/or the expansion spatial content 1600d.

For example, the interactive space content 1600c may provide an active music experience function, a video experience function, a passive music experience function, a content purchase function for an artist, and a music video generation function. The active music experience function may refer to a function of providing an audio source and a visual source corresponding to a user input received while providing a 3D space (or a map space) included in a character. For example, the user device 20 may provide a function of outputting sound corresponding to a motion of the character, outputting sound (e.g., a specific sound, a lyric) corresponding to a graphic object that interacts with the character in the 3D space, moving from the 3D space to another space to output sound of another timeline, or encountering a star object implemented in the 3D space, and collecting at least one visual source disposed in the 3D space. The function of outputting sound (e.g., a specific sound, a lyric) corresponding to a graphic object that interacts with the character in the 3D space may be based on an active experience file in a clip unit, and the function of moving from the 3D space to another space to output sound of another timeline may be based on an active experience file in a track unit. The passive music experience function may refer to a function of providing an audio effect and a visual effect according to the position of the character while the music is passively reproduced. The video experience module provides a video viewing function, and sound based on the audio source may be output according to whether the screen is activated or not by allocating different audio sources for each of the plurality of screens. The content purchase function for the artist may include a function of purchasing a photocard of the artist for a music file corresponding to the metaverse music content 1600 or a function of saving a star character corresponding to the artist. The music video generation function may include a function of recording a motion using a character (avatar) in accordance with the music being reproduced, and the recorded content may be shared to another user.

For example, the extended content 1600d may perform a function of searching for and providing a planet object of another user based on a planet object produced by the user. In this case, the music experienced by the other user may be shared based on the reproduction of an audio source corresponding to a visual source implemented in the planet object of the other user.

4.1. Sequential Music Providing Operation when Moving a Character

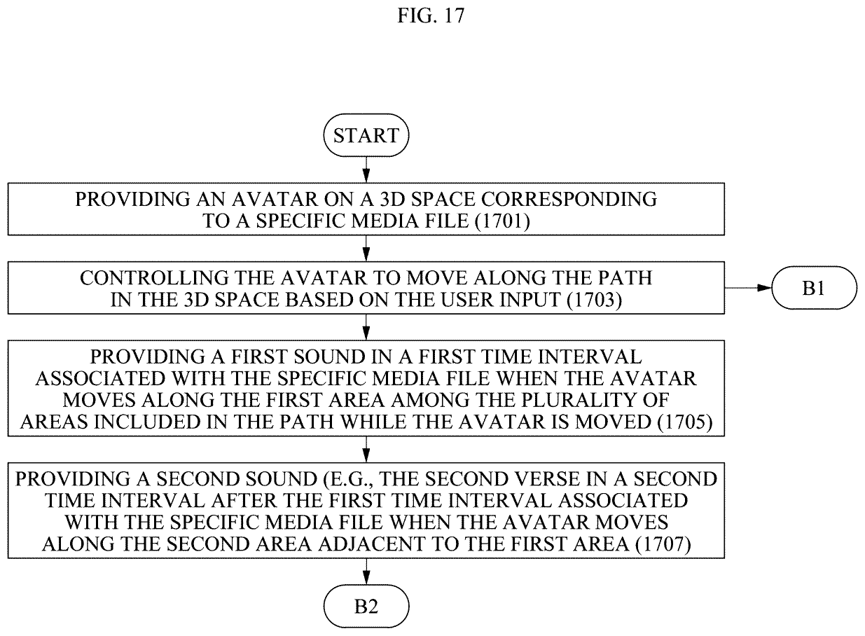

FIG. 17 is a flowchart illustrating an example of an operation method of an electronic device (e.g., a server 10 and a user device 20) for sequentially providing music when moving a character according to various embodiments. However, operations may be performed in an order different from the order of the operations described and/or illustrated, and more or fewer operations may be performed than the operations described and/or illustrated.

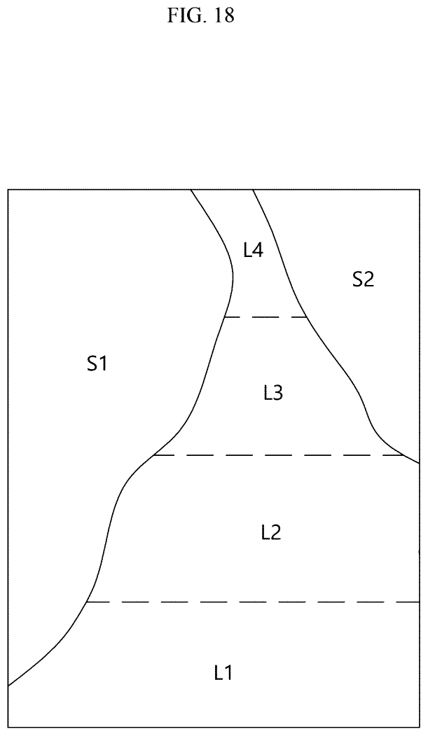

FIG. 18 is a diagram illustrating an example of an audio source set along a path of a map space according to various embodiments.

According to various embodiments, an electronic device (e.g., a server 10 and a user device 20) may provide an avatar on a 3D space corresponding to a specific media file in operation 1701. For example, the electronic device (e.g., the server 10 and the user device 20) may provide the metaverse music content 1600 as described above based on executing the active appreciation file based on the playing module 500. In this case, the metaverse music content 1600 (e.g., the interactive space content 1600c) may include an avatar and a 3D space as described above. Referring to FIG. 18, the 3D space may include a path l1, l2, l3, and l4 through which the avatar is movable and a space s1 and s2 through which the avatar is not movable. The movable path includes a plurality of areas L1, L2, L3, and L4 through which the characters may move sequentially, and different verses may be set for each of the plurality of areas L1, L2, L3, and L4. The verses may be set in the order corresponding to the order of the plurality of areas through which the characters are moved. For example, when the starting point of the character is located in the first area l1 and the movement target point of the character is located in the fourth area l4, and the character is moved along the first area l1, the second area l2, the third area l3, and the fourth area l4, the first verse of the music file may be set in the first area l1, the second verse provided sequentially after the first verse may be set in the second area l2, the third verse provided sequentially after the second verse may be set in the third area l3, and the fourth verse provided sequentially after the third verse may be set in the fourth area l4.

According to various embodiments, the media file may include a plurality of active appreciation files, and each of the plurality of active appreciation files may include a different area of the path and a corresponding verse as a visual source. Accordingly, the user device 20 may reproduce the verse corresponding to the specific area when the character is located in the specific area on the path based on the plurality of active appreciation files.

According to various embodiments, the electronic device (e.g., the server 10 and the user device 20) may control the avatar to move along the path in the 3D space based on the user input in operation 1703, and provide a first sound (e.g., the first verse) in a first time interval associated with the specific media file when the avatar moves along the first area among the plurality of areas included in the path while the avatar is moved in operation 1705, and provide a second sound (e.g., the second verse) in a second time interval after the first time interval associated with the specific media file when the avatar moves along the second area adjacent to the first area in operation 1707. As described above, the verse may be set sequentially in the order of the plurality of areas l1, l2, l3, and l4 through which the characters are movable. The user device 20 may reproduce the verse corresponding to the specific area when the character is located in the path based on the plurality of the active appreciation files.

### 4.1.1. A Sound Providing Operation Corresponding to the Motion of the Character

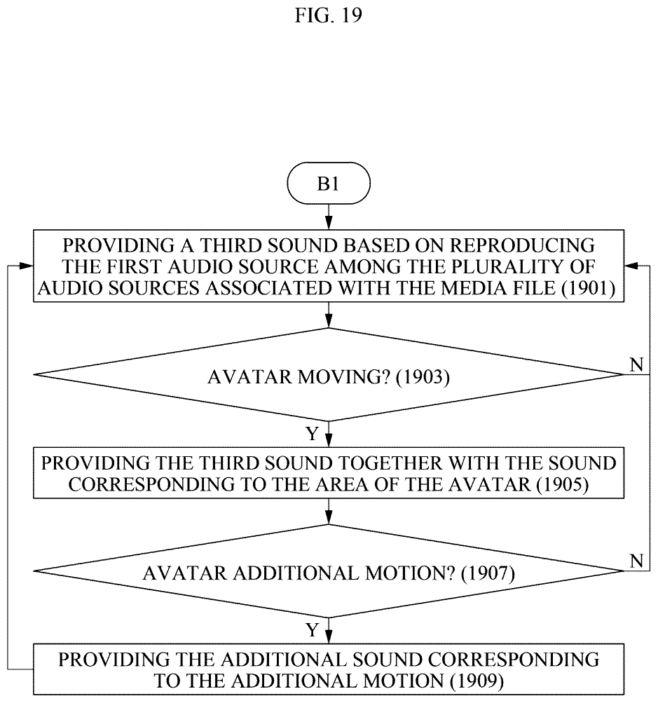

FIG. 19 is a flowchart illustrating an example of an operating method of an electronic device (e.g., the server 10 and the user device 20) for providing sound corresponding to the motion of the character according to various embodiments. However, the operations may be performed in an order different from the order of the operations described and/or illustrated, and more or fewer operations may be performed than the operations described and/or illustrated.

According to various embodiments, in operation 1901, the electronic device (e.g., the server 10 or the user device 20) may provide a third sound based on reproducing the first audio source among the plurality of audio sources associated with the media file. For example, as described above, the electronic device (e.g., the server 10 or the user device 20) may provide metaverse music content 1600. The electronic device (e.g., the server 10 or the user device 20) may output sound based on reproducing the pre-set base audio source regardless of movement of the character (or the avatar).

According to various embodiments, the electronic device (e.g., the server 10 or the user device 20) may determine whether the avatar is moved in operation 1903, and when the avatar is identified as being moved, the electronic device (e.g., the server 10 or the user device 20) may provide the third sound together with the sound corresponding to the area of the avatar (1903-y) in operation 1905. For example, when the input for moving the avatar of the user is received, the electronic device (e.g., the server 10 or the user device 20) may output sound by further reproducing the bulk corresponding to the specific area of the path where the avatar is located based on the active appreciation file while reproducing the pre-set base audio source. On the other hand, when the movement of the avatar is not identified (1903-n), the electronic device (e.g., the server 10 or the user device 20) may maintain only the above-described reproduction of the pre-set base audio source.

According to various embodiments, the electronic device (e.g., the server 10 or the user device 20) may determine whether the additional motion of the avatar is performed in operation 1907, and when the additional motion is performed, the electronic device (e.g., the server 10 or the user device 20) may further provide additional sound corresponding to the additional motion (1907-y) in operation 1909. For example, when the input of the user for performing the motion of the avatar or the interaction between the avatar and another graphic object in the space 3D (e.g., a position within a predetermined distance) is identified, the electronic device (e.g., the server 10 or the user device 20) may provide the additional sound by reproducing a specific audio source based on the active appreciation file corresponding to the identified user interaction.

4.2. Graphical Object Generation Operation Associated with a Musical Experience

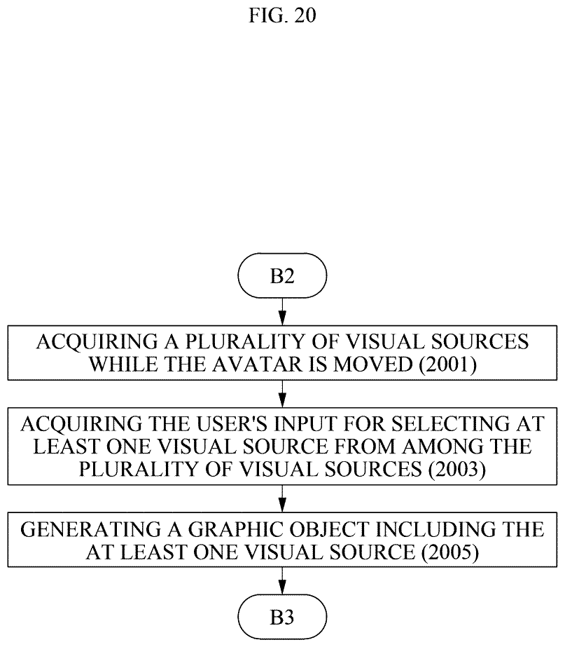

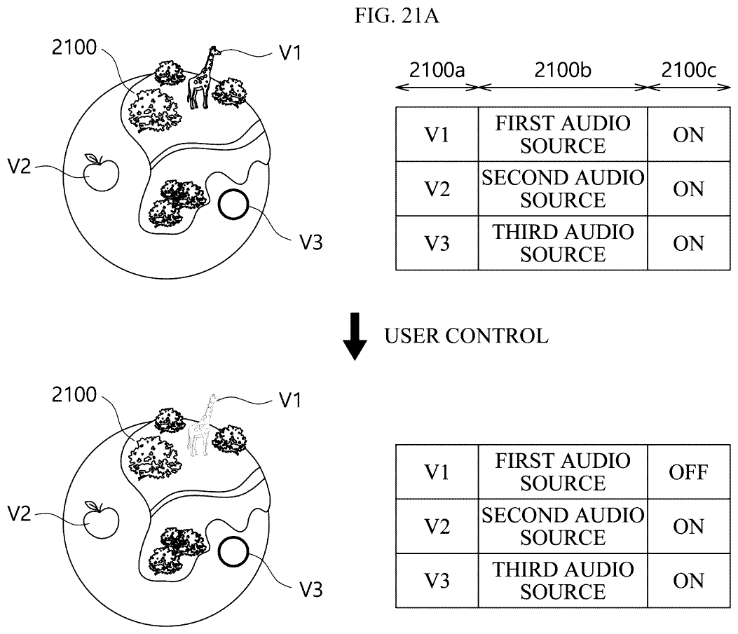

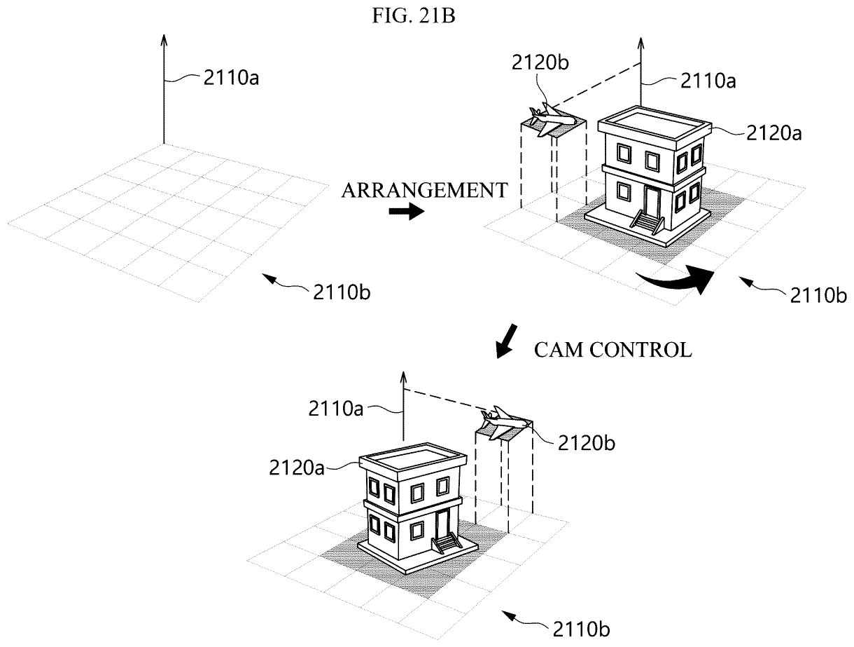

FIG. 20 is a flowchart illustrating an example of an operation method of an electronic device (e.g., the server 10 or the user device 20) for generating a graphic object associated with a musical experience according to various embodiments. However, operations may be performed in an order different from the order of the operations described and/or illustrated, and more or fewer operations may be performed than the operations described and/or illustrated. Hereinafter, FIG. 20 will be described with reference to FIG. 21a.

FIG. 21A is a diagram for describing examples of reproduction of audio based on graphic objects associated with a musical experience according to various embodiments. FIG. 21B is a diagram for describing examples of reproduction of audio based on graphic objects associated with a musical experience according to various embodiments.

According to various embodiments, the electronic device (e.g., the server 10 or the user device 20) may acquire a plurality of visual sources while the avatar is moved in operation 2001. While providing the above-described metaverse music content 1600 (e.g., the interactive space content 1600c), the electronic device (e.g., the server 10 or the user device 20) may acquire at least one visual element collected by the avatar while moving the avatar (or the character) in the 3D space based on the user's input. For example, visual elements that can be collected by the character may be disposed in areas l1, l2, l3, l4 of the path in which the avatar is movable in the 3D space. For example, when the character is positioned within a pre-set distance from the visual elements, or when a control input for acquiring the visual element is received, the visual element may be acquired. The plurality of active appreciation files associated with the metaverse music content 1600 may include an audio source stored in a form associated with the visual element acquired by the character.

According to various embodiments, the electronic device (e.g., the server 10 or the user device 20) may acquire the user's input for selecting at least one visual source from among the plurality of visual sources in operation 2003 and generate a graphic object including the at least one visual source in operation 2005. For example, the electronic device (e.g., the server 10 or the user device 20) may provide a list including the plurality of visual sources collected by the avatar on the metaverse music content 1600 (e.g., the standby space content 1600b) and receive the user's input for selecting at least one visual source from among the plurality of visual sources. Referring to FIG. 21, the electronic device (e.g., the server 10 or the user device 20) may generate the graphic object 2100 of the user by disposing at least one visual source v1, v2, and v3 selected by the user in the graphic object 2100 (e.g., the planet object). The graphic object 2100 may be implemented to output sound by the electronic device (e.g., the server 10 or the user device 20) by reproducing at least one audio source. For example, the electronic device (e.g., the server 10 or the user device 20) may output sound based on the information 2100a on at least one visual source disposed in the graphic object 2100, the information 2100b on at least one audio source corresponding to the at least one visual source, and the information 2100c on the activation state for determining whether to reproduce the audio source for each at least one visual source. For example, referring to FIG. 21, while the electronic device (e.g., the server 10 or the user device 20) displays the graphic object 2100, the electronic device may output sound by reproducing only the audio source corresponding to the specific visual element (v1, v2, and v3) where the reproduction of the audio source is activated by the user. On the other hand, when audio reproduction of all visual elements disposed in the graphic object 2100 is deactivated, only pre-set base audio sources may be reproduced and sound may be provided.

According to various embodiments, the electronic device (e.g., the server 10 or the user device 20) may edit the visual attributes (e.g., size, position, color) of at least one visual element v1, v2, and v3 disposed in the graphic object 2100 and/or edit the auditory attributes (e.g., volume, pitch, etc.) of audio sources corresponding to the at least one visual element v1, v2, and v3 based on the input of the user.

According to various embodiments, the electronic device (e.g., the server 10 or the user device 20) may share the generated graphic object 2100 with another user. For example, the electronic device (e.g., the server 10 or the user device 20) may generate content (e.g., the initial space content 1600a) including the graphic object 2100 and share the generated content to the outside (e.g., transmit to an external electronic device).

Meanwhile, referring to FIG. 21B, according to various embodiments, the electronic device (e.g., the server 10 or the user device 20) may be implemented to output sound according to the arrangement position of the graphic objects 2120a and 2120b and the camera viewpoint. For example, referring to FIG. 21B, the electronic device (e.g., the server 10 or the user device 20) may provide a three-dimensional space that can be arranged of graphic objects, and the three-dimensional space may include a two-dimensional plane 2110b and a height dimension 2111a. The electronic device (e.g., the server 10 or the user device 20) may arrange the graphic objects 2120a and 2120b in a specific plane and a specific position based on the input of the user. The electronic device (e.g., the server 10 or the user device 20) may output sound based on the type of the graphic objects 2120a and 2120b and the audio file associated with the arranged position. When the camera viewpoint for the three-dimensional space is changed based on the input of the user, the electronic device (e.g., the server 10 or the user device 20) may change the output sound. For example, the volume of the first sound corresponding to the graphic object (e.g., the building object 2120a) that is better visually viewed according to the change of the camera viewpoint may be larger than the volume of the second sound corresponding to the other graphic object (e.g., the airplane object 2120b). In this case, the arranged graphic object (e.g., the airplane object 2120b) may be moved in the three-dimensional space, and the output sound may be changed based on the changed position of the graphic object (e.g., the volume degree is controlled according to the degree of view).

### 4.3. Musical Experience Sharing Operation

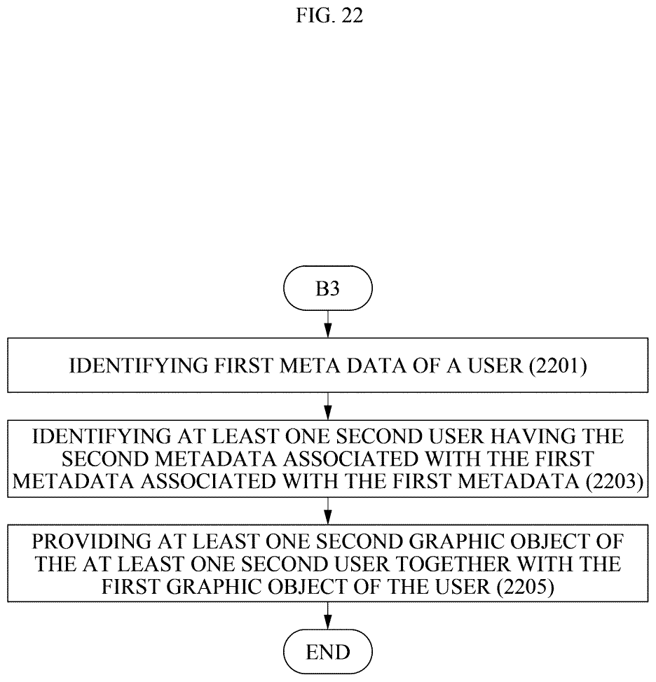

FIG. 22 is a flowchart illustrating an example of an operation method of an electronic device (e.g., the server 10 or the user device 20) for sharing a musical experience according to various embodiments. However, operations may be performed in an order different from the order of the described and/or illustrated operations, and more or fewer operations may be performed than the described and/or illustrated operations. Hereinafter, FIG. 20 will be further described with reference to FIG. 21.

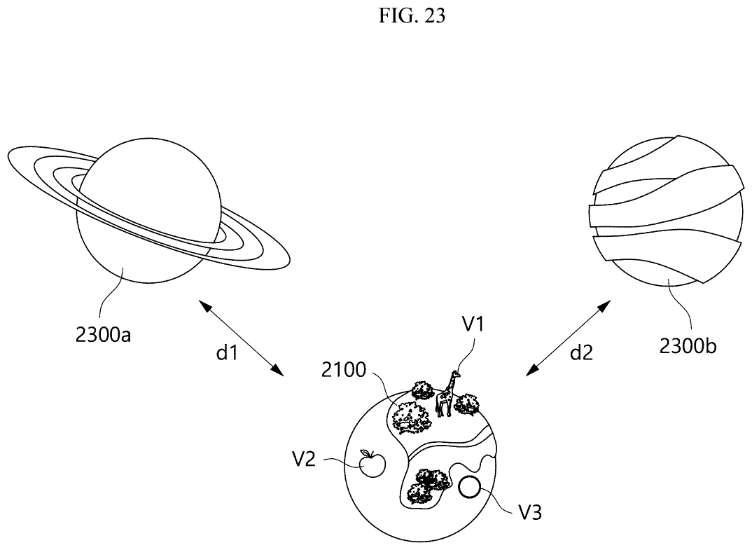

FIG. 23 is a diagram illustrating an example of an operation for sharing a graphic object associated with a musical experience for each user.

According to various embodiments, the electronic device (e.g., the server 10 or the user device 20) may identify the first metadata of the user in operation 2201 and may identify at least one second user having the second metadata associated with the first metadata associated with the first metadata in operation 2203. For example, the metadata may include personal information (e.g., age, gender) of the user and information associated with the musical experience of the user (e.g., artist corresponding to the music file and the type of music file). The electronic device (e.g., the server 10 or the user device 20) may generate values (e.g., vector values) for each of personal information (e.g., age, gender) and information associated with a musical experience for search, and search for other users having values similar to the obtained values. The generated value may be a representative vector value, such as an average of the generated vector values, but is not limited to the described example.

According to various embodiments, the personal information of the user may include information on the current emotion of the user. For example, the electronic device (e.g., the server 10 or the user device 20) may acquire the user's emotion information by inputting text input from the user into ai for emotion analysis.

According to various embodiments, the information related to the user's musical experience may further include a musical mood. For example, the electronic device (e.g., the server 10 or the user device 20) may obtain information about a musical mood by analyzing an audio source corresponding to the visual elements (v1, v2, and v3) where audio playback is activated among the visual elements (v1, v2, and v3) constituting the graphic object 2100 described above.

According to various embodiments, the electronic device (e.g., the server 10 or the user device 20) may provide at least one second graphic object of the at least one second user together with the first graphic object of the user in operation 2205. For example, referring to FIG. 23, each of the graphic objects 2100, 2300a, and 2300b may be graphic objects generated based on visual sources V1, V2, and V3 collected by respective users, and may be a graphic object that provides a reproduction function of an audio source as described above. The electronic device (e.g., the server 10 or the user device 20) may provide a screen on which the graphical objects 2300a and 2300b of other users searched around the graphical object 2100 of the user are arranged, based on the similarity between the user and the other user. In this case, distances d1 and d2 between the graphic object 2100 and the graphic objects 2300a and 2300b may indicate similarities between the user and other users. The distance and the similarity are inversely proportional, and the closer the distance may have a greater similarity.

According to various embodiments, the electronic device (e.g., the server 10 and the user device 20) may output music that other users appreciate based on the graphic objects 2300a and 2300b of other users provided on the screen. For example, the electronic device (e.g., server 10 or user device 20) may identify a specific graphical object selected by a user from among objects 2300a and 2300b of other users and output music experienced by other users based on playing audio sources corresponding to visual sources arranged in the specific graphical object. In this case, whether to reproduce audio for each visual source arranged in a specific graphical object of another user may be determined by the user.

### 5. Application Operation Using Active Appreciation Files.

### 5.1. Active Experience Music Video Generation Operation

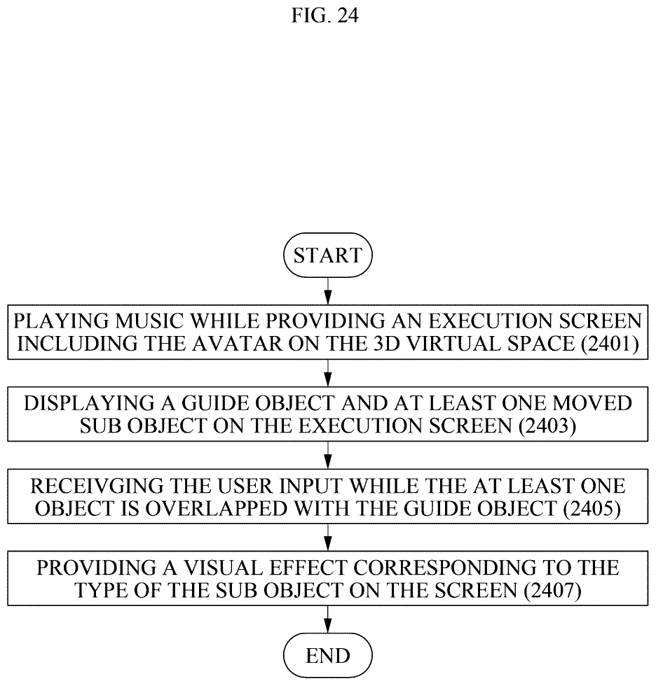

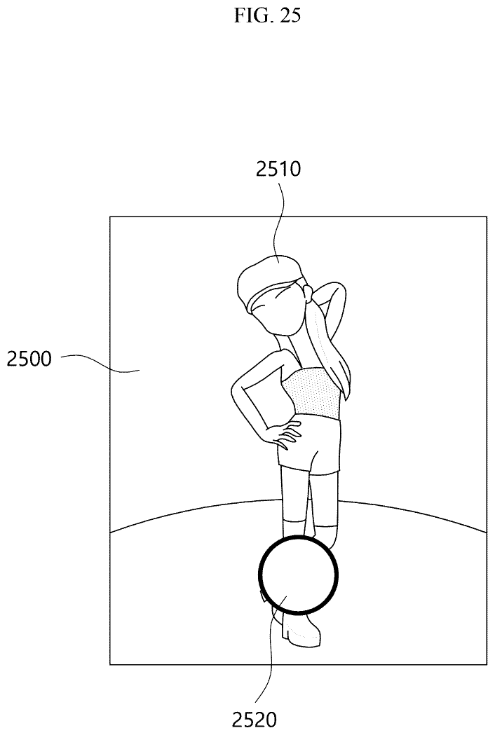

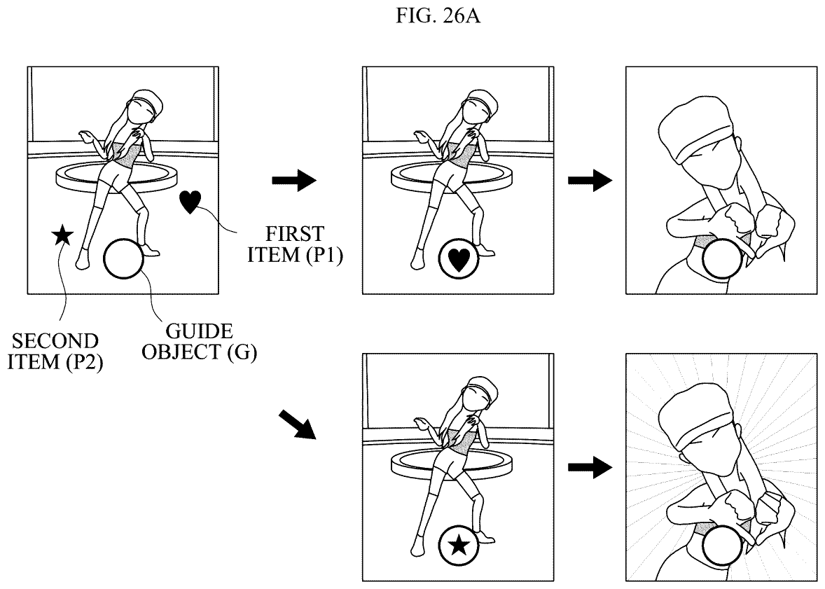

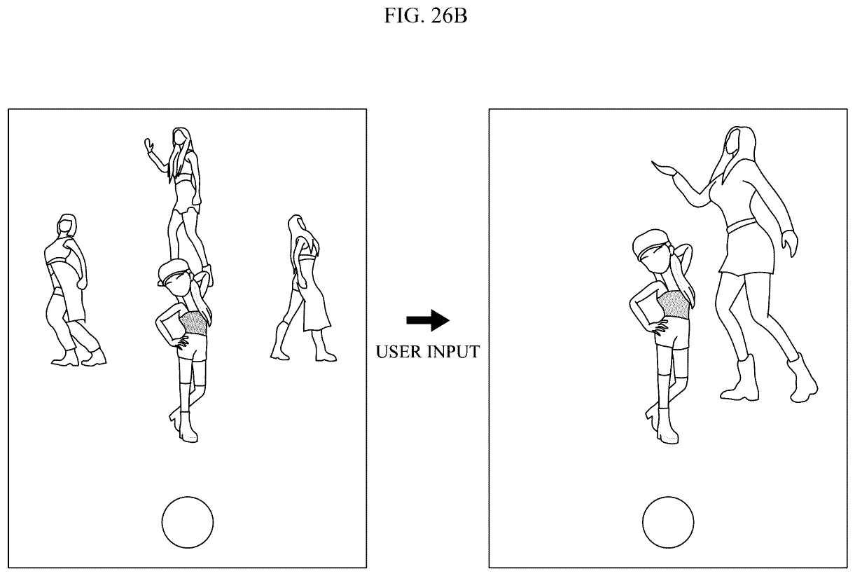

FIG. 24 is a flowchart illustrating an example of an operation method of an electronic device (e.g., a server 10 or a user device 20) for generating active experience music video according to various embodiments. However, operations may be performed in an order different from the order of the operations described and/or illustrated, and more or fewer operations may be performed than the operations described and/or illustrated. Hereinafter, FIG. 24 will be further explained with reference to FIG. 25 to FIG. 26.

FIG. 25 is a diagram illustrating an example of content for music video generation according to various embodiments. FIG. 26A is a diagram illustrating an example of active music video generation based on active appreciation file according to various embodiments. FIG. 26B is a diagram illustrating another example of active music video generation based on active appreciation file according to various embodiments.

According to various embodiments, the electronic device (e.g., the server 10 or the user device 20) may play music while providing an execution screen 2500 including the avatar 2510 on the 3D virtual space in operation 2401, and display a guide object 2520 and at least one moved sub object on the execution screen 2500 in operation 2403. For example, the electronic device (e.g., the server 10 or the user device 20) may acquire information on the space in which the music to be played and the avatar 2510 are to be arranged from the user to generate music video for the specific music, and configure the execution screen 2500 based on the acquired music and the information on the space to be arranged. The guide object 2520 is a graphic object set to receive the user input, and when the user input is received while at least one sub object is located on the guide object 2520, a visual effect and/or an audio effect may be provided based on the active appreciation file corresponding thereto.

According to various embodiments, the electronic device (e.g., the server 10 or the user device 20) may receive the user input while the at least one object is overlapped with the guide object in operation 2405, and provide a visual effect corresponding to the type of the sub object on the screen in operation 2407, and/or output an audio effect. For example, referring to FIG. 26A, the visual effect and/or the audio effect provided according to the type of the sub object (e.g., the first item P1 and the second item P2) disposed on the guide object 2520 may be different. For example, when the user input is received while the first item P1 is arranged, the first visual effect of changing the screen to the first color may be provided and the first sound may be output, and when the user input is received while the second item P2 is arranged, the second visual effect of changing the screen to the second color may be provided and the second sound may be output.

According to various embodiments, when the user input is received while the sub object is arranged on the guide object 2520, the electronic device (e.g., the server 10 or the user device 20) may change the photographing attributes such as the angle and the photographing distance of the avatar 2510 provided on the execution screen 2500, but is not limited to the example.

According to various embodiments, referring to FIG. 26B, the electronic device (e.g., the server 10 or the user device 20) may arrange and provide artists selected artists together with the user's avatar. In addition, the electronic device (e.g., the server 10 or the user device 20) may provide a function of photographing a screen (i.e., self-photographing with an artist) while at least some of the artists selected by the user are displayed.

### 5.2. Active Experience Item Generation Operation

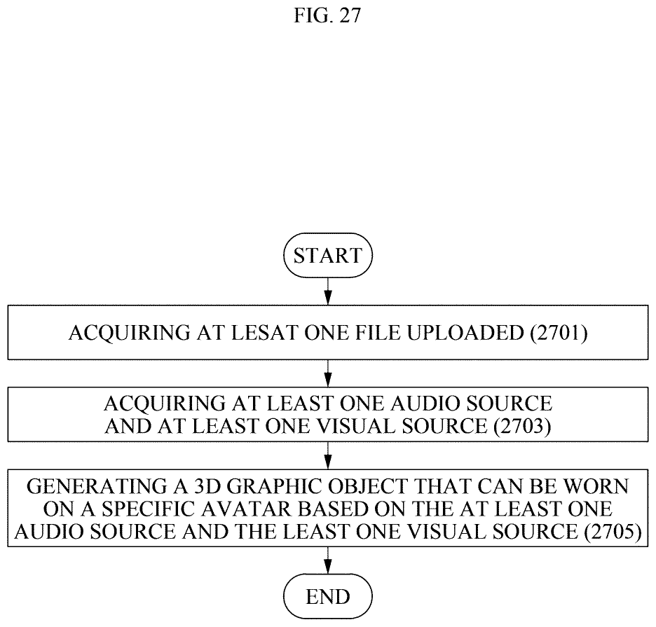

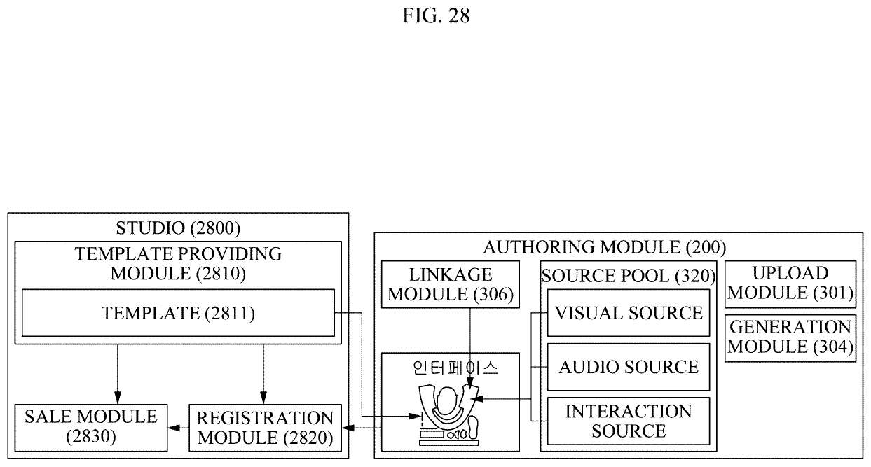

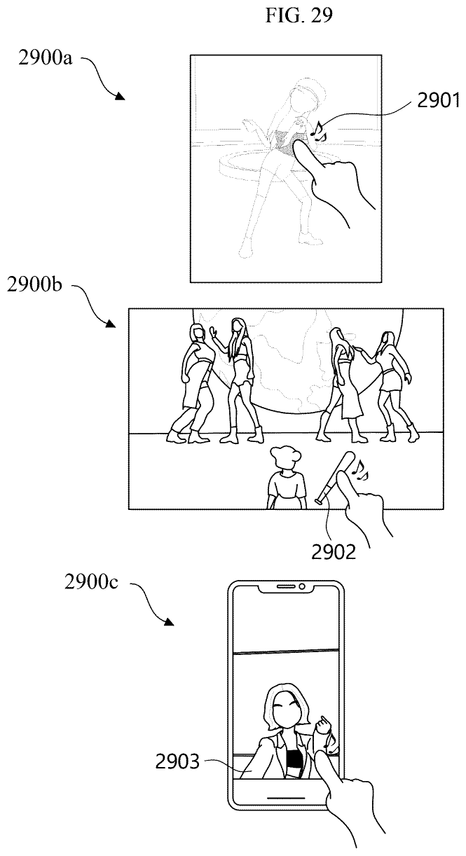

FIG. 27 is a flowchart illustrating an example of an operating method of an electronic device (e.g., the server 10 or the user device 20) for generating active experience items according to various embodiments. However, operations may be performed in an order different from the order of the operations described and/or illustrated, and more or fewer operations may be performed than the operations described and/or illustrated. Hereinafter, FIG. 27 will be further described with reference to FIGS. 28 to 29.

FIG. 28 is a diagram illustrating an example of an operation of generating active experience items using the authoring module 200 according to various embodiments. FIG. 29 is a diagram illustrating an example of using active experience items according to various embodiments.

According to various embodiments, the electronic device (e.g., the server 10 or the user device 20) may acquire at least one file uploaded in operation 2701. For example, referring to FIG. 28, the electronic device (e.g., the server 10 or the user device 20) may receive a template 2811 provided from the studio program 2800 of the external server and generate active experience items illustrated in FIG. 29 using the template 2811 and the authoring module 200 described above. The template 2811 is a drawing file provided to produce a specific item, and when a visual element is arranged on the template 2811 and is converted, a 3D item in which the visual element is arranged may be generated. The 3D item may be used in the metaverse music content 1600 or the metaverse space (or 3D space, game space) operated in the external server. As described above, the electronic device (e.g., the server 10 or the user device 20) may acquire a music file and/or a graphic file for generating active experience items from the user using the upload module 301 of the authoring module 200.

According to various embodiments, the electronic device (e.g., the server 10 or the user device 20) may provide a list including a plurality of 3D items to the user and receive a template for the 3D item selected from the plurality of 3D items from the template providing module 2810 of the studio program 2800.

According to various embodiments, the electronic device (e.g., the server 10 or the user device 20) may acquire at least one audio source and at least one visual source in operation 2703, and generate a 3D graphic object that can be worn on a specific avatar based on the at least one audio source and the at least one visual source in operation 2705. For example, the electronic device (e.g., the server 10 or the user device 20) may generate the active experience file together with the edited template 3811 for generating the 3D item using the authoring module 200. As described above, the electronic device (e.g., the server 10 or the user device 20) may separate at least one source based on the basis of the music file and/or the graphic file, and/or generate at least one source using the generating module 303. Thereafter, the electronic device (e.g., the server 10 and the user device 20) may provide an interface for arranging the at least one visual source on the template 2811 and generating an active appreciation file. The electronic device (e.g., the server 10 and the user device 20) may generate the edited template 2811 by receiving a user input for arranging at least one visual source on the template 2811 provided in the interface, and generate an active experience file including an audio source and a user interaction for the at least one visual source arranged using the linkage module 306 in a related form. As a result, the edited template 2811 is generated as a 3D item wearable by an avatar in the metaverse space by the studio program 2800 of the external server, and the 3D item may provide a playback and visual effect of an audio source when a specific type of user input is received on the 3D item based on the active experience file.

According to various embodiments, referring to FIG. 29, the generated 3D item may be used in various metaverse contents. For example, referring to 2900a of FIG. 29, the 3D item 2901 may be available in music video content, and an audio effect and a visual effect based on the active experience file may be provided when the 3D item 2901 (e.g., 3D clothing item) worn by the character is touched by the user. For example, referring to 2900b of FIG. 29, the 3D item 2902 may be available in metaverse concert content, and an audio effect and a visual effect based on the active experience file may be provided when the 3D item 2902 (e.g., 3D appeal item) worn by the character is touched by the user. Accordingly, the experience of participating in the concert may be provided more actively as well as simply listening to music while experiencing the concert in the metaverse space. For example, referring to 2900c of FIG. 29, the 3D item 2902 may be available in metaverse SNS content, and an audio effect and a visual effect based on the active experience file may be provided when the 3D item 2903 (e.g., capital item) worn by the character is touched by the user. That is, as the active experience file is provided along with content provided to another external user, an audio/visual effect based on the user input may be provided.

According to various embodiments, the electronic device (e.g., the server 10 and the user device 20) may register the generated 3D item in the external server through the registration module 2820 of the studio program 2800 and may be sold by another user through the sale module 2830, and the electronic device (e.g., the server 10 and the user device 20) may store the generated 3D item in the external server.

### 5.3 Digital Album Object Generation Operation

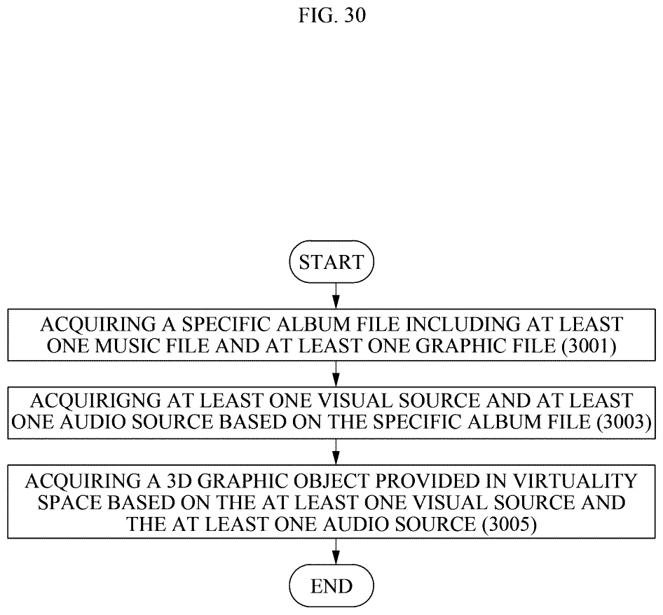

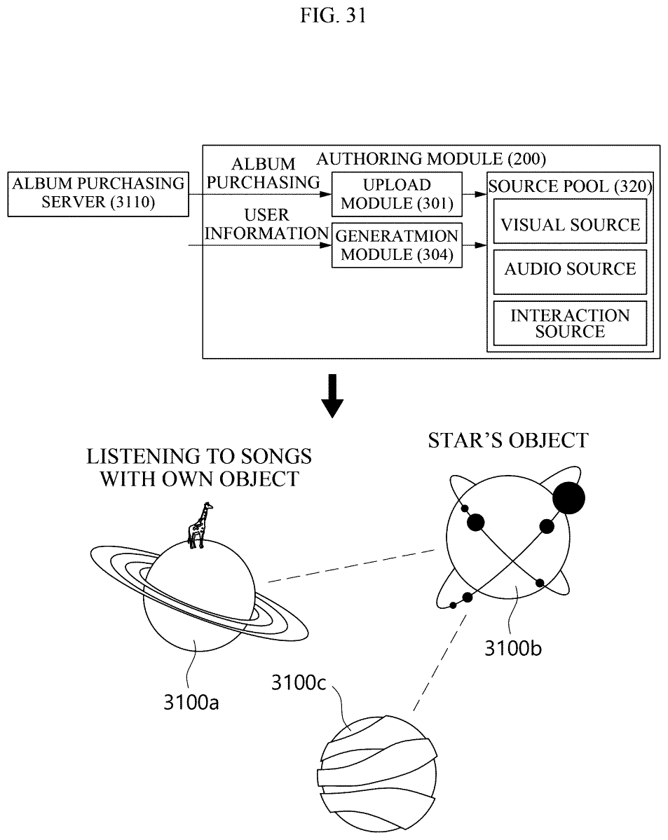

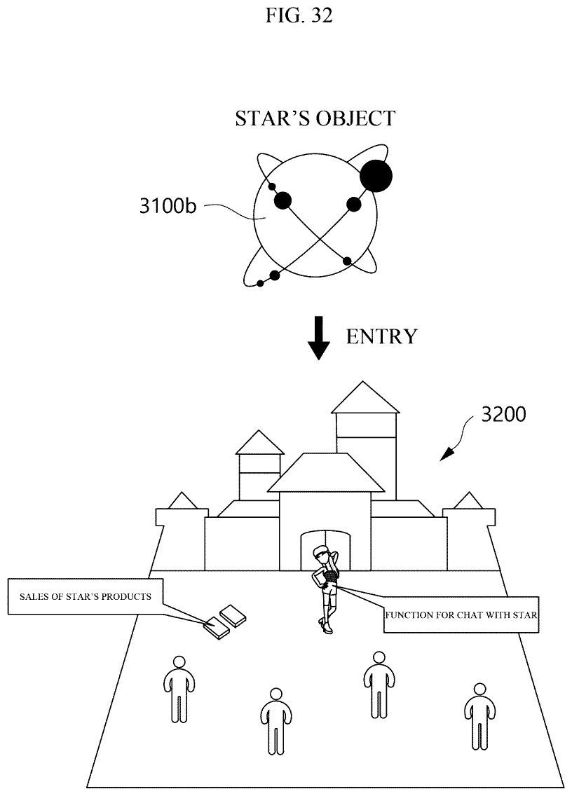

FIG. 30 is a flowchart illustrating an example of an operation method of an electronic device (e.g., the server 10 and the user device 20) for generating a digital album object according to various embodiments. However, operations may be performed in an order different from the order of the operations described and/or illustrated, and operations may be performed more or less than the operations described and/or illustrated. Hereinafter, FIG. 30 will be further described with reference to FIGS. 31 to 32.

FIG. 31 is a diagram illustrating an example of an operation of generating a digital album object by using the authoring module 200 according to various embodiments. FIG. 32 is a diagram illustrating an example of using a star object according to various embodiments.

According to various embodiments, the electronic device (e.g., the server 10 and the user device 20) may acquire a specific album file including at least one music file and at least one graphic file in operation 3001. For example, referring to FIG. 31, the electronic device (e.g., the server 10 and the user device 20) may acquire a file related to an album purchased by a user through the upload module 301. The file related to the album may include a music file of a specific artist and visual content such as a bromide of a specific artist as a graphic file. The file may be purchased by the user from an album purchasing server 3110.

According to various embodiments, the electronic device (e.g., the server 10 and the user device 20) may acquire at least one visual source and at least one audio source based on the specific album file in operation 3003 and acquire a 3D graphic object provided in virtuality space based on the at least one visual source and the at least one audio source in operation 3005. For example, the electronic device (e.g., the server 10 and the user device 20) may provide the user with at least one source (e.g., visual source and audio source) generated based on the file related to the album and generate a digital album object 3100a of the user only generated based on the at least one source. The electronic device (e.g., the server 10 and the user device 20) may separate at least one source based on the file related to the album and/or generate at least one source based on the generation module 303. The operation of using the generation module 303 may include receiving information about personal information (e.g., gender and age) of the user and generating the at least one source by further considering the received personal information of the user. The resulting generated digital album object 3100a includes a visual source arranged by the user, such as the graphic object 2100 (e.g., the planet object), and may reproduce music according to the reproduction of the audio source corresponding to the visual source. As the music of the artist is produced by the user as the digital album object 3100a, the immersion degree of the music emotion may be improved. In addition, the objects 3100c of other users who purchased the album of the artist may be searched for, and redundant descriptions thereof will be omitted.

According to various embodiments, the electronic device (e.g., the server 10 and the user device 20) may provide a star object 3100b of a pre-implemented artist (or star). Referring to FIG. 32, the electronic device (e.g., the server 10 and the user device 20) may provide a 3D space 3200 in which characters corresponding to the artist are arranged based on the input of the user. The 3D space 3200 may provide a chatting function with the characters of other users entering the star object 3100b, a chatting function with the characters corresponding to the star, and aa purchase/sell function with articles related to the star. The chatting function with the other characters may be based on a chat-bot, but may be based on a chat input directly by another user or star in connection.

### 5.4. Active Learning Object Generation Operation

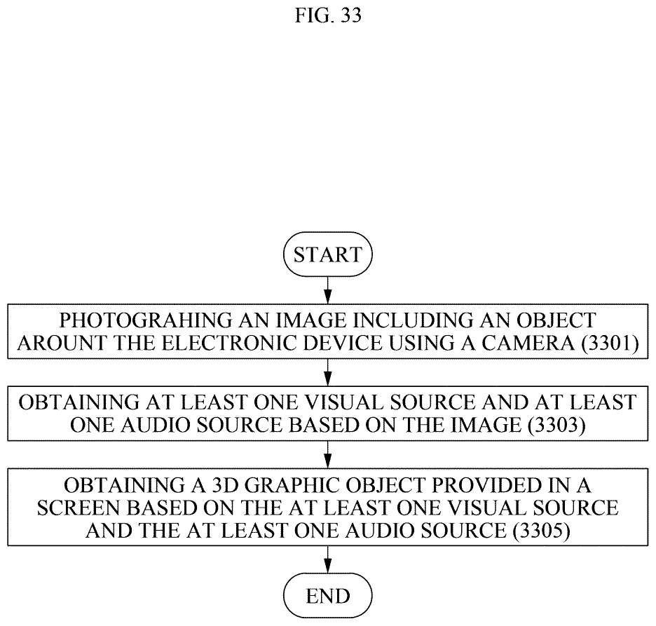

FIG. 33 is a flowchart illustrating an example of an operating method of an electronic device (e.g., server 10 or user device 20) for generating an active learning object according to various embodiments. However, operations may be performed in a different order than the order of the operations described and/or illustrated, and more or fewer operations may be performed than the operations described and/or illustrated. Hereinafter, FIG. 27 will be further described with reference to FIGS. 28 to 29.

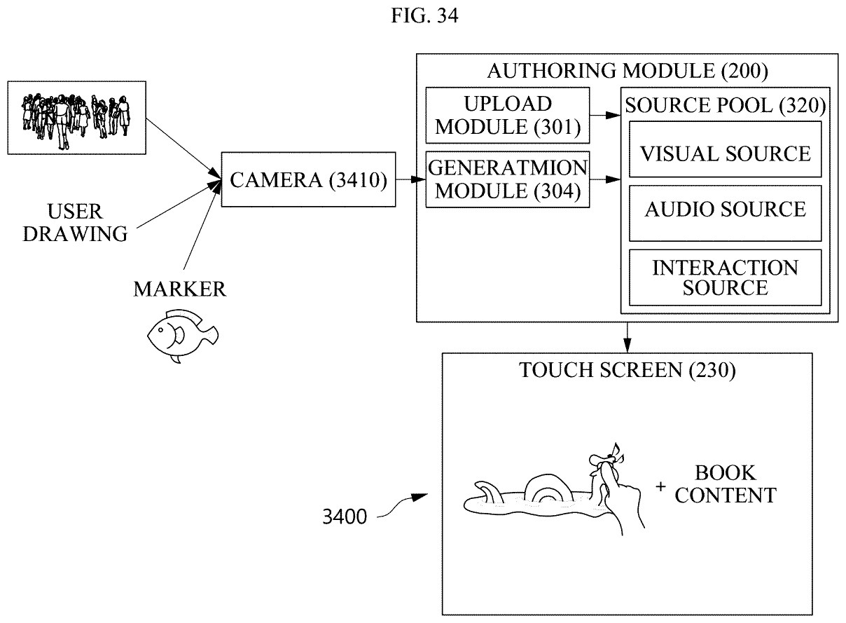

FIG. 34 is a diagram illustrating an example of an operation of generating an active learning object using the authoring module 200 according to various embodiments.

According to various embodiments, the electronic device (e.g., server 10 or user device 20) may photograph an image including an object around the electronic device using a camera in operation 3301. For example, referring to FIG. 36, the electronic device (e.g., server 10 or user device 20) may photograph a real book and a marker (or drawing) disposed by the learner in the real book using a camera 3410.

According to various embodiments, the electronic device (e.g., server 10 or user device 20) may obtain at least one visual source and at least one audio source based on the image in operation 3303 and obtain a 3D graphic object provided in a screen of the electronic device based on the at least one visual source and the at least one audio source in operation 3305. The electronic device (e.g., server 10 or user device 20) may generate at least one source (e.g., a visual source and an audio source) based on the image photographed using the generation module 303 of the authoring module 200, and redundant descriptions are omitted. The electronic device (e.g., server 10 or user device 20) may generate an active learning object including a visual source, an audio source, and an interaction stored in a related form according to the input of the learner and provide a screen 3400 including the generated active learning object and book content corresponding to the page of the current real book on the touch screen 230. The active learning object may be implemented to provide a visual source and an audio source based on the input of the user. Accordingly, content expanded further from the content provided through the real book may be experienced, thereby enhancing the imagination of the learner and increasing the utility of the real book.

What is claimed is:

1. A method of operating a server, the method comprising:
obtaining an audio file and a graphic file;
obtaining a plurality of audio sources and a plurality of visual sources based on at least one of the audio file or the graphic file;
obtaining a plurality of processed audio sources based on changing characteristics of at least some of the plurality of audio sources;
obtaining a plurality of processed visual sources based on changing characteristics of at least some of the plurality of visual sources; and
generating at least one active experience file based on generating at least one first audio source selected from the plurality of processed audio sources, at least one first visual source selected from the plurality of processed visual sources, and a specific type of interaction selected by a user in a related form; and
wherein, when the specific type of interaction is received based on the at least one active experience file, the electronic device of the user is configured to provide the at least one first audio source and the at least one first visual source.

2. The method of claim 1, wherein the obtaining of the plurality of audio sources comprises:
obtaining the plurality of audio sources based on a separation of the audio file, wherein the audio file is a recorded file at once in an environment in which sound corresponding to the plurality of audio sources is provided.

3. The method of claim 1, wherein the obtaining of the plurality of visual sources comprises:
obtaining the plurality of visual sources based on a separation of the graphic file, wherein the graphic file is the 3D graphic file.

4. The method of claim 3, wherein the plurality of visual sources comprises at least one of at least one graphic object included in the 3D virtual space, or a visual effect.

5. The method of claim 1, wherein:
when the type of the at least one active experience file is a first type, the user device is configured to provide the at least one first audio source and the at least one first visual source while maintaining a track being provided based on the interaction of the user of the specific type is received, and
when the type of the at least one active experience file is a second type, the user device is configured to provide the at least one first audio source and the at least one first visual source while changing a track being provided based on the interaction of the user of the specific type is received.

6. The method of claim 5, wherein the at least one audio source provided and/or the at least one visual source provided is implemented to be different based on the type of the audio file and the type of the graphic file.

7. The method of claim 6, further comprising:
obtaining a 3D virtual space including the plurality of graphic sources, wherein:
when the type of the audio file is a first type, the at least one active experience file is configured to provide a first type sound based on the interaction of the user of the specific type with respect to the at least one graphic source included in the 3D virtual space, and
when the type of the audio file is a second type, the at least one active experience file is configured to provide a second type sound based on the interaction of the user of the specific type with respect to the at least one graphic source included in the 3D virtual space.

8. The electronic device of claim 6, further comprising:
obtaining a 3D virtual space including the plurality of graphic sources, wherein:
when the type of the graphic file is a first type, the at least one active experience file is configured to provide a specific sound based on the interaction of the user with the first type of graphic source included in the 3D virtual space is received, and
when the type of the audio file is a second type, the at least one active experience file is configured to provide the specific sound based on the interaction of the user with the second type of graphic source included in the 3D virtual space is received.

9. The electronic device of claim 1, further comprising:
obtaining at least one file from a user; obtaining a prompt based on the at least one file; and
obtaining at least one media context representing characteristics of audio and characteristics of video based on the prompt and at least one AI model, and obtaining at least one audio source and at least one visual source based on the at least one media context.

10. The electronic device of claim 9, further comprising:
generating a file that stores the obtained at least one audio source and the at least one visual source in a related form using the at least one AI model.

11. The electronic device of claim 1, further comprising:
identifying an event related to the active experience file, wherein the event is an event for a specific visual source in the file and a specific audio source configured to be related to the specific visual source;
identifying event time information related to a time at which the event occurs; identifying audio specification information and graphic specification information of the electronic device; and
providing the event based on the specific visual source and the specific audio source based on the event time information, the audio specification information, and the graphic specification information.

12. The electronic device of claim 11, wherein the event time information related to the time at which the event occurs is related to a musical unit.

13. The electronic device of claim 11, wherein the at least one processor is configured to:
obtain an audio file and a graphic file,
obtain a plurality of audio sources and a plurality of visual sources based on at least one of the audio file or the graphic file, obtain a plurality of processed audio sources based on changing characteristics of at least some of the plurality of audio sources,
obtain a plurality of processed visual sources based on changing characteristics of at least some of the plurality of visual sources, and
generate at least one active experience file based on generating a specific type of interaction selected by the user from at least one first audio source selected from the plurality of processed audio sources, and a plurality of visual sources in a related form, and
wherein the electronic device of the user is configured to provide the at least one first audio source and the at least one first visual source when the interaction of the specific type is received based on the at least one active experience file.

14. The electronic device of claim 13, wherein the at least one processor is configured to:
obtain the plurality of audio sources based on separation of the audio file, and wherein the audio file is a file recorded at a time in an environment in which sound corresponding to the plurality of audio sources is provided.

15. The electronic device of claim 13, wherein the at least one processor is configured to:
acquire the plurality of visual sources based on the separate graphic file, and wherein the graphic file is the 3D graphic file.
